(19) United States
(12) Patent Application Publication
(10) Pub. No.: US 2026/0105318 A1
(43) Pub. Date: Apr. 16, 2026

(54) SYSTEM AND METHOD FOR HETEROGENEOUS PERSONALIZED FEDERATED LEARNING BY LOCAL-GLOBAL UPDATES MIXING VIA CONVERGENCE RATE

(71) Applicant: The Chinese University of Hong Kong, Hong Kong (CN)

(72) Inventors: Qi Dou, Shatin (HK); Meirui Jiang, Shatin (HK)

(21) Appl. No.: 18/911,457

(22) Filed: Oct. 10, 2024

(51) Int. Cl. G06N 3/098; G06N 3/04

(52) U.S. Cl. CPC G06N 3/098; G06N 3/04

(57) ABSTRACT

A computing system includes a local processing unit having a local artificial intelligence (AI) engine for training a first set of input data to generate a local update, and a remote server having a global AI engine for aggregating one or more client AI engines for training a second set of input data to generate a global update. The first set of input data has an identical sample space to that of the second set of input data, and the first set of input data has a different feature space from the second set of input data. The local AI engine generates a local model based on a combination of the local update and the global update received from the remote server by the local processing unit in accordance with a ratio λ_c, to 1−λ_c calculated by a convergence function that depends on a Gram matrix H(t).

### TECHNICAL FIELD

This invention relates to a method and system for heterogeneous personalized federated learning by local-global updates mixing via convergence rate.

### BACKGROUND

Personalized federated learning (PFL) aims to leverage the aggregated knowledge from other clients to learn a client-specific model that best fits its own data distribution. Although many PFL methods have tackled heterogeneity issues regarding label distribution shift, computation limitation, model architecture design, etc, how to effectively address the feature heterogeneity issue is still an open question.

In practice, feature distributions across client data are often heterogeneous due to variations in acquisition or generation conditions. For instance, in the healthcare domain, medical images collected from different hospitals exhibit appearance misalignment as imaging protocol changes.

Training one common global model for tackling various feature distributions can be challenging. Therefore, personalization of the global FL model to each individual client becomes imperative, but how to solve the feature heterogeneity is still unclear.

There have been many approaches proposed to improve the global model in order to tackle heterogeneous features. Despite the promising performance, the converged global model may not be optimal for all clients. Another way is to train personalized models to overcome the feature distribution shifts. It is worth noting that dealing with heterogeneous features under PFL setting is largely different from doing it under standard FL. Specifically, PFL aims to fit clients' individual feature distribution, whereas the standard FL focuses on utilizing various feature distributions to enhance the global model. For instance, there are some FL methods proposed to tackle the heterogeneous data by aligning the feature distribution over clients to promote global aggregation, and rectifying client gradient direction to avoid aggregated gradients being distracted. These methods mainly focus on global updates. However, for PFL, it is essential to consider both local and global updates and their interplay relations for achieving personalization.

To investigate the relations, the effects during federated training between local and global updates have been considered. The global update typically is the aggregation (e.g., weighted averaging) of local updates, while the local update solely relies on the client's local data. In federated training, the global update contains common knowledge from all clients' data, thereby aiding in minimizing the error of joint data distribution. However, it may not precisely align with the direction of the local update when the data exhibits heterogeneity. For local update, it specifically minimizes the local error, but suffers from limited local data size. From a personalization standpoint, the key incentive is to minimize the local error with the help of other clients' data (i.e., the common knowledge). In this case, an ideal solution would be leveraging local updates to rectify the potential adverse effects induced by data heterogeneity in global updates. A promising solution is to mix the local and global updates, while the question is how to determine the mixing ratio.

To promote the training of a global model on heterogeneous data, various techniques have been proposed, such as regularizing local model training (Li et al., 2020b; Durmus et al., 2021; Li et al., 2021a), facilitating model optimization (Karimireddy et al., 2020; Reddi et al., 2021; Tran Dinh et al., 2021), enhancing aggregation algorithm (Wang et al., 2020; Pillutla et al., 2019), improving feature normalization (Li et al., 2021c; Reisizadeh et al., 2020), etc. For instance, SCAFFOLD (Karimireddy et al., 2020) proposed a new optimization algorithm to reduce variance in local updates. Later on, FedNova (Wang et al., 2020) suggested using normalized stochastic gradients for global model aggregation, and MOON (Li et al., 2021a) proposed using contrastive learning on latent feature representations to enhance the alignment between local and global models. FedDC (Gao et al., 2022) improved SCAFFOLD by dynamically updating the client objective function. However, when aiming to maximize the performance for each local client, learning one common global model may not be an optimal solution.

The PFL aims to utilize data from multiple clients to learn a personalized model for each client. Existing methods have performed personalization by leveraging meta-learning (Fallah et al., 2020; Acar et al., 2021), multi-task learning (Smith et al., 2018; Li et al., 2021b), model parameters decomposition (Collins et al., 2021; Oh et al., 2022), model mixture (Deng et al., 2020; Hanzely et al., 2020; Hanzely & Richtarik, 2021), Bayesian treatment (Kotelevskii et al., 2022; Ozkara et al., 2023), etc. For example, PerFedAvg (Fallah et al., 2020) proposed to seek a meta-model that adapts to each client's local dataset. APFL (Deng et al., 2020) and L2SGD (Hanzely et al., 2020) proposed to mix the local and global model for personalization. FedAlt (Pillutla et al., 2022) proposes to personalize partial model layers. FedBABU (Oh et al., 2022) and FedRep (Collins et al., 2021) propose a similar idea of decoupling the learning model into a model body and a local head, and the head is personalized. Recently, FedHKD (Chen et al., 2023) proposes to use knowledge distillation to train local models and share hyper-knowledge instead of parameters. However, although some optimization-based methods (e.g., APFL, L2SGD) can be extended for heterogeneous features, they are not specifically designed for feature heterogeneity problems. The issue of feature distributional shifts in PFL remains under-explored.

### SUMMARY OF THE INVENTION

According to a first aspect of the invention, there is provided a computing system comprising:
a local processing unit having a local artificial intelligence (AI) engine for training a first set of input data to generate a local update, and
a remote server having a global AI engine for aggregating one or more client AI engines for training a second set of input data to generate a global update;
wherein the first set of input data has an identical sample space to that of the second set of input data, and the first set of input data has a different feature space from the second set of input data;
wherein the local AI engine is adapted to generate a local model based on a combination of the local update and the global update received from the remote server by the local processing unit in accordance with a ratio calculated by a convergence function.

In an embodiment of the first aspect, the convergence function depends on a Gram matrix H(t).

In an embodiment of the first aspect, the Gram matrix H(t) is generated by a function of parameter w and input x of an AI engine,

In an embodiment of the first aspect, the ratio between the local update and global update are λ_{c}, and 1−λ_{c} respectively.

In an embodiment of the first aspect, λ_{c}(t)=tr(H_{c}(t))/(tr(H_{c}(t))+tr(H(t))) and tr(H) is a trace of a matrix H.

In an embodiment of the first aspect, λ_{c}(t)=tr(Σ_{c}(t))/(tr(Σ_{c}(t))+tr(Σ(t))), wherein h denotes the parameters up to the penultimate layer of an AI engine,

$$\sum ( t ) = {\sum }_{i = 1}^{n} h ( {x}_{i} ) {h ( {x}_{i} )}^{T}$$

is a feature matrix in [symbol] ^{m×m} considering features among all samples.

In an embodiment of the first aspect,

$${λ}_{c} ( t ) = \frac{1}{t - 1} {\sum }_{i = 1}^{t - 1} {λ}_{c} ( i ) .$$

In an embodiment of the first aspect, the AI engine comprises any one of an artificial neural network, a convolution neural network, or a U-Net.

In an embodiment of the first aspect, the global AI engine is adapted to generated a global update by aggregating one or more remote client updates received from one or more remote client AI engine, such that the global updates Δu(t)=Σ_{c}p_{c}Δw_{c}(t), wherein p_{c} denotes the client importance.

In an embodiment of the first aspect, the local model is generated by the algorithm comprising the step of:

Algorithm: Personalized FL Framework for Inside and Outside Clients

| 1 | Inside personalization | | | |
|---|---|---|---|---|
| | Input | communication rounds T, number of clients N, local update steps K, client learning | | |
| | | $rate {η}_{l} , global learning rate {η}_{g} , mixing ratio {\{ {λ}_{c} \}}_{c = 1}^{N} , feature matrix {\{ {Σ}_{c} \}}_{c = 1}^{N} , Σ .$ | | |
| 2 | for t = 0, 1, . . . , T − 1 do | | | |
| 3 | \| | for c = 1, 2, . . . , N in parallel do | | |
| 4 | \| | \| | for k = 0, 1, . . . , K − 1 do | |
| 5 | \| | \| | \| | sample a batch of data pairs {(xᵢ, yᵢ)}, i ∈ S_{c} |
| 6 | \| | \| | \| | w_{c}(t, k + 1) ← SGD (w_{c}(t, k); {(xᵢ, yᵢ)}) // also output feature h_{c} (xᵢ) |
| 7 | \| | \| | └ | Σ_{c} += h_{c}(xᵢ)h_{c}(xᵢ)^{T}, Σ += h(xᵢ)h(xᵢ)^{T} // update feature matrix |

| 8 | \| | └ | Δw_{c}(t) = w_{c}(t, K) − w_{c}(t, 0) // send client update to server |
|---|---|---|---|
| 9 | \| | u(t + 1) = u(t) + Δu(t), where Δu(t) = Σ_{c}p_{c} Δw_{c}(t) // global model update | |
| 10 | \| | for c = 1, 2, . . . , N in parallel do | |
| 11 | \| | \| | λ_{c}(t) = tr(Σ_{c}(t))/(tr(Σ_{c}(t)) + tr(Σ(t))) //Eq. (6) |
| 12 | └ | └ | w_{c}(t + 1) ← w_{c}(t) + λ_{c}(t)Δw_{c}(t) + (1 − λ_{c}(t))Δu(t) //Eq. (2) |

| | $Output : The personalized models {\{ {w}_{c} \}}_{c = 1}^{N} , and the global model u .$ | |
|---|---|---|
| 13 | Outside personalization | |
| 14 | Initialize R(n, l) = 1/(N + 1) for all n = [N + 1], l = [L], build routing space | |
| | W̅ = R · [w₁, . . . , w_{N}, u]^{T} | |
| 15 | for samples i = 1, . . . , nₒ do | |
| 16 | \| | ${\overline{y}}_{i}^{o} = {f}_{{w}_{o}} ( {x}_{i}^{o} ) model inference$ |
| 17 | └ | R =_{R} [symbol] test-time update, Eq. (13) wₒ = R · [w₁, . . . , w_{N}, u]^{T} |

| | |
|---|---|
| 18 | return wₒ |

In an embodiment of the first aspect, the system further comprises a method of generating a outside personalisation model, wherein the method of generating a outside personalisation model comprising the steps of:
initialising R(n, l)=1/(N+1) for all n=[N+1], l=[L] for building a build routing space \tilde{W}=R·[w₁, . . . , W_{N}, u]^{T} with the steps of:
for samples i=1, . . . , no do

$${\overline{y}}_{i}^{o} = {f}_{{w}_{o}} ( {x}_{i}^{o} )$$

model inference,
R=_{R} [symbol] ₜ test-time update, where

$${ℒ}_{t} = {ℒ}_{cons} ( {x}_{i}^{o} , {x}_{i}^{o} + ϵ ; R ) + β ( {ℒ}_{s} ( {x}_{i}^{o} ; R ) + {ℒ}_{e} ( {x}_{i}^{o} ; R ) ) ,$$

$${w}_{o} = R \cdot {[ {w}_{1} , … , {W}_{N} , u ]}^{T}$$

In an embodiment of a second aspect of the present invention, there is provided a computer-implemented method comprising:
processing a first set of input data with a local AI engine, wherein the AI engine has an input layer, a hidden layer, an output layer, and a loss function model, to obtain a local update;
receiving a global update from a remote server, wherein the remote server has a global AI engine for aggregating one or more client AI engines for training a second set of input data; and wherein the first set of sample data has an identical sample space to that of the second set of input data, and the first set of sample data has a different feature space from the second set of input data;
generating a local model based on a combination of the local update and the global update received from the remote server by the local processing unit in accordance with a ratio calculated by a convergence function.
   In an embodiment of a third aspect, there is provided a computing system for processing medical images comprising:
a local processing unit having a local U-Net artificial intelligence (AI) engine for training a first set of input data to generate a local update, and
a remote server having a global AI engine for aggregating one or more client U-Net AI engines for training a second set of input data to generate a global update;
wherein the first set of input data comprises medical images collected from one medical imaging device, and the second set of input data comprises medical images collected from one or more different medical image devices, such that the first set of input data exhibits appearance misalignment from the second set of input data;
wherein the local AI engine is adapted to generate a local model based on a combination of the local update and the global update received from the remote server by the local processing unit in accordance with a ratio λ_{c}, to 1−λ_{c} calculated by a convergence function that depends on a Gram matrix H(t) generated by a function of parameter w and input x of an AI engine;
and λ_{c}(t)=tr(Σ_{c}(t))/(tr(Σ_{c}(t))+tr(Σ_{c}(t))), wherein h denotes the parameters up to the penultimate layer of an AI engine,

$$\sum ( t ) = {\sum }_{i = 1}^{n} h ( {x}_{i} ) {h ( {x}_{i} )}^{T}$$

is a feature matrix in [symbol] ^{m×m} considering features among all samples.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present invention will now be described, by way of example, with reference to the accompanying drawings in which:

FIG. 1 is computer system for implementing a method for heterogeneous personalized federated learning by local-global updates mixing via convergence rate in accordance with an embodiment of the present invention.

FIG. 2 is a schematic diagram of a local artificial engine in accordance with an embodiment of the present invention.

FIG. 3 is an image showing samples of five datasets of various styles and appearances used in an embodiment of the present invention.

FIG. 4, at (a), provides an image showing analytical studies on key features of our method including the personalization weight changes; at (b), provides an image showing analytical studies on key features of our method including the benefits of personalization via observing feature values; and, at (c), provides an image showing analytical studies on key features of our method including client scalability.

FIG. 5 is image showing two graphs representing distance between local and global model on the classification and segmentation model.

FIG. 6 is an image showing three graphs representing training loss, validation loss, and validation accuracy by comparison including the FedAvg, the top 3 ranked SOTA methods, and the method according to embodiment of the present invention on the Digits5 dataset.

FIG. 7 is a schematic diagram of an overview of the updates mixing method for inside client model personalization in accordance with a preferred embodiment of the present invention.

FIG. 8 is a schematic diagram of test-time parameter routing shows that all trained models contain diverse distribution information.

FIG. 9 is a drawing showing qualitative visualization of segmentation results with the inside-outside personalization method and other state-of-the-art methods.

FIG. 10 is an illustration of images for the visualization of inversion attacks to reconstruct samples.

### DETAILED DESCRIPTION OF THE PREFERRED EMBODIMENT

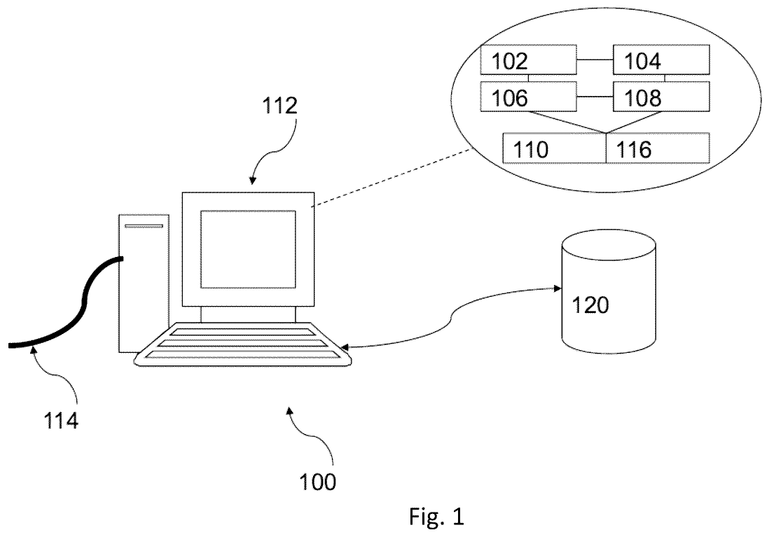

With reference to FIGS. 1, 2, and 7, an embodiment of the present invention is illustrated. This embodiment is arranged to provide a system and method heterogeneous personalized federated learning to achieve model personalization by Local-Global updates Mixing (LGMix). One of the novel and inventive features of the present is the determination of the mixing ratio via NTK-based convergence. Specifically, the trace of NTK is an effective measurement of the convergence rate. By leveraging the convergence rate induced by NTK, the present invention is adapted to implement local and global updates, and perform mixing based on their importance. The present invention is adapted to provide an efficient and effective approximation to calculate the trace of a feature matrix instead of the NTK matrix. This approximation not only reduces the computational cost, but also explicitly considers heterogeneous features among samples. Experiments have demonstrated the efficacy of the system and method of the present invention, including both performance comparisons and analytical studies. Analysis has been conducted in the convergence of the system and method of the present invention in the over-parameterized regime. These experiments include three computer vision datasets with heterogeneous features (diverse image styles/appearances), and two real-world medical image datasets. It has been shown that the system and method of the present invention consistently outperforms state-of-the-art approaches across all datasets, showing its effectiveness in personalization.

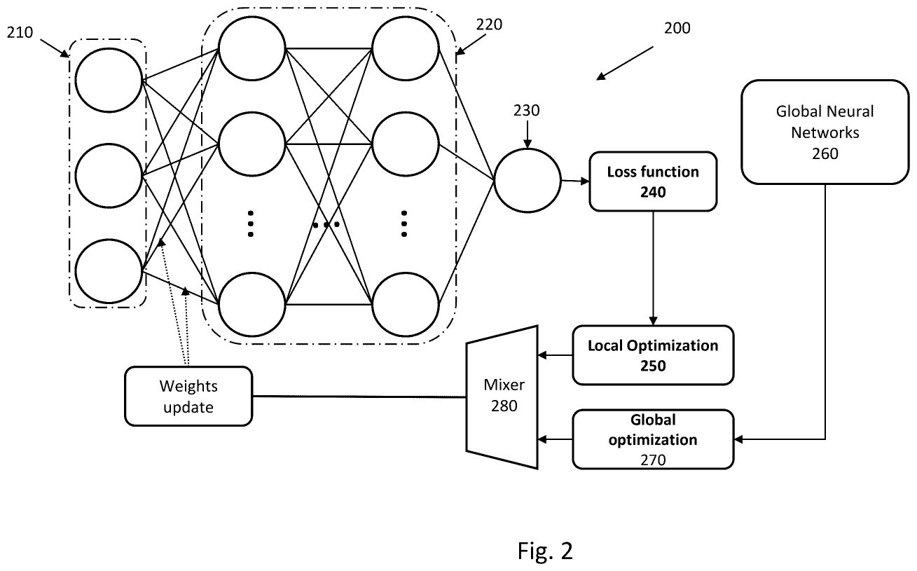

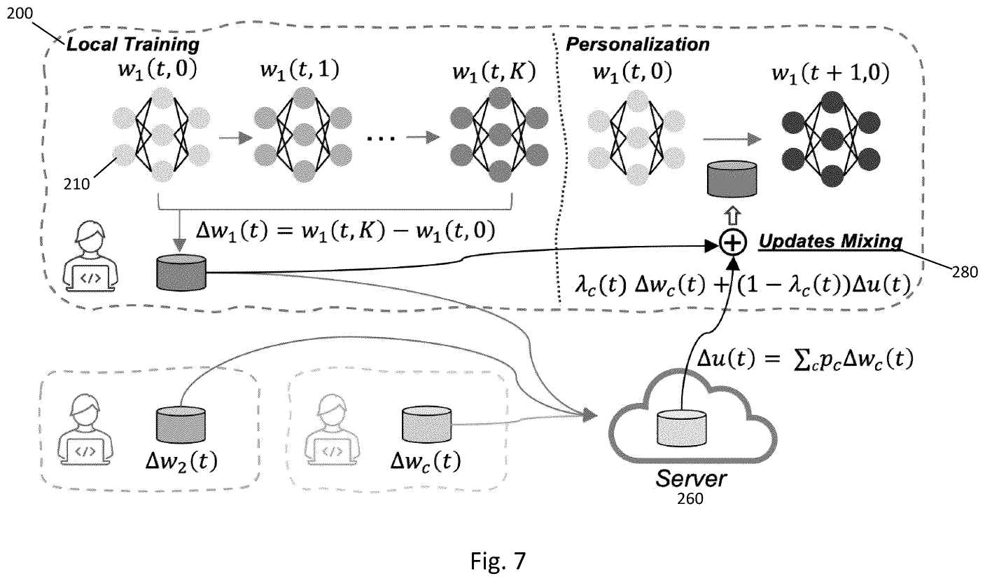

In one embodiment of the present invention, there is provided a computing system comprising a local processing unit 100 as shown in FIG. 1 having a local artificial intelligence (AI) engine 200 as shown in FIG. 2 and FIG. 7 for training a first set of input data to generate a local update, and a remote server having a global AI engine or global neural network 260 for aggregating one or more client AI engines for training a second set of input data to generate a global update. The first set of input data has an identical sample space to that of the second set of input data, and the first set of input data has a different feature space from the second set of input data; The local AI engine is adapted to generate a local model based on a combination of the local update and the global update received from the remote server by the local processing unit in accordance with a ratio calculated by a convergence function. The convergence function depends on a Gram matrix H(t). The Gram matrix H(t) is generated by a function of parameter w and input x of an AI engine, The ratio between the local update and global update are λ_{c}, and 1−λ_{c} respectively. In one embodiment, the ratio coefficient λ_{c}(t)=tr(H_{c}(t))/(tr(H_{c}(t))+tr(H(t))) and tr(H) is a trace of a matrix H. In another embodiment, the ratio coefficient λ_{c}(t)=tr(Σ_{c}(t))/(tr(Σ_{c}(t))+tr(Σ_{c}(t))), wherein h denotes the parameters up to the penultimate layer of an AI engine,

$$\sum ( t ) = {\sum }_{i = 1}^{n} h ( {x}_{i} ) {h ( {x}_{i} )}^{T}$$

is a feature matrix in [symbol] ^{m×m} considering features among all samples. In another embodiment, the ratio coefficient

$${λ}_{c} ( t ) = \frac{1}{t - 1} {\sum }_{i = 1}^{t - 1} {λ}_{c} ( i ) .$$

The global AI engine is adapted to generate a global update by aggregating one or more remote client updates received from one or more remote client AI engine, such that the global updates Δu(t)=Σ_{c}p_{c}Δw_{c}(t), wherein p_{c} denotes the client importance. FIG. 7 shows a schematic diagram of an overview of the updates mixing method for inside client model personalization in accordance with a preferred embodiment of the present invention. The personalized model is generated by combining local and global updates with a specified ratio.

In one +embodiment the AI engine comprises any one of an artificial neural network, a convolution neural network, or a U-Net.

In one embodiment, the AI engine 200 comprises an input layer 210, a hidden layer 220, and an output layer 230. The AI engine 200 further comprises a loss function module for calculating the distance between the desired label and the output generated from the output layer 230. There is also provided a local optimization module 250 to generate a local update to the local model. In one embodiment of the present invention there is provided a mixer 280 for combining the local update generate by the local neural network and a global update received from a global optimization module 270 of the global neural networks 260. The mixer 280 is adapted to generate a local model by combining the local update and the global update received from the remote server by the local processing unit in accordance with a ratio λ_{c}, to 1−λ_{c} calculated by a convergence function that depends on a Gram matrix H(t).

In another embodiment of the present invention, there is provided a computing system for processing medical images comprising: a local processing unit having a local U-Net artificial intelligence (AI) engine for training a first set of input data to generate a local update, and a remote server having a global AI engine for aggregating one or more client U-Net AI engines for training a second set of input data to generate a global update. The first set of input data comprises medical images collected from one medical imaging device, and the second set of input data comprises medical images collected from one or more different medical image devices, such that the first set of input data exhibits appearance misalignment from the second set of input data. The local AI engine is adapted to generate a local model based on a combination of the local update and the global update received from the remote server by the local processing unit in accordance with a ratio λ_{c}, to 1−λ_{c} calculated by a convergence function that depends on a Gram matrix H(t) generated by a function of parameter w and input x of an AI engine and λ_{c}(t)=tr(Σ_{c}(t))/(tr(Σ_{c}(t))+tr(Σ(t))), wherein h denotes the parameters up to the penultimate layer of an AI engine,

$$\sum ( t ) = {\sum }_{i = 1}^{n} h ( {x}_{i} ) {h ( {x}_{i} )}^{T}$$

is a feature matrix in [symbol] ^{m×m} considering features among all samples.

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

Turning first to FIG. 1, there is a shown a schematic diagram of a computer system or computer server 100 which is arranged to be implemented as an example embodiment of a system for heterogeneous personalized federated learning by local-global updates mixing via convergence rate. This embodiment comprises a server 100 which includes suitable components necessary to receive, store, and execute appropriate computer instructions. The components may include a processing unit 102, including Central Processing Units (CPUs), Math Co-Processing Unit (Math Processor), Graphic Processing Unit (GPUs) or Tensor Processing Units (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display, or any other suitable display and communications links 114 may also be present. The server 100 may include instructions that may be included in ROM 104, RAM 106, or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, and edge computing devices. At least one of a plurality of communication links may be connected to an external computing network through a telephone line or other type of communication links.

In another embodiment of the present invention, there is provided an application-specific integrated circuit (ASIC) for an artificial neural network which is arranged to be implemented as an example embodiment of a system for heterogeneous personalized federated learning by local-global updates mixing via convergence rate. The ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the pluralities of synaptic circuits.

The server 100 may also include storage devices such as a disk drive 108 which may encompass solid state drives, hard disk drives, optical drives, magnetic tape drives, or remote or cloud-based storage devices. The server 100 may use a single disk drive or multiple disk drives, or a remote storage service. The server 100 may also have a suitable operating system 116 which resides on the disk drive or in the ROM of the server 100.

The computer or computing apparatus may also provide the necessary computational capabilities to operate or to interface with a machine learning network, such as a neural network, to provide various functions and outputs. The neural network may be implemented locally, or it may also be accessible or partially accessible via a server or cloud-based service. The machine learning network may also be untrained, partially trained, or fully trained, and/or may also be retrained, adapted, or updated over time.

One embodiment of the present invention is described in an example of a model training process implemented in the aforementioned computer system 100 or ASIC. The model training process involves data sources received from local and global updates. The method performs update mixing guided by the convergence.

One embodiment of the present invention, there is provided a method and system for heterogeneous personalized federated learning by local-global updates mixing via convergence rate. A heterogeneous federated learning is characterized in that the clients' feature spaces are different, but the sample space is the same.

Personalized federated learning (PFL) aims to utilize data from multiple clients to learn a personalized model for each client. Existing methods have performed personalization by leveraging: meta-learning, multi-task learning, model parameters decomposition, model mixture, Bayesian treatment, etc. However, although some optimization-based methods (e.g., APFL, L2SGD) can be extended for heterogeneous features, they are not specifically designed for feature heterogeneity problems. The issue of feature distributional shifts in PFL remains under-explored.

There are currently some works aiming to improve the performance of federated models on outside unseen sites. However, the global model in these methods is not dedicatedly optimized toward the distribution of outside clients; thus, it still cannot ensure performance for unseen clients. Besides, extra training costs for these methods (e.g., frequency information sharing in FedDG and domain generator in FedADG) need to be considered.

### Local and Global Updates Mixing

For convenience of explanation, it is assumed that there are N clients joining the PFL for T communication rounds, and c is used to denote the client index. Each client will perform K local update steps. The aggregated server model at the t-th communication round is denoted as u(t) and the client model in round t and local step k as w_{c}(t, k). Denote S_{c} as the data index of client c, assuming there are n input data and label pairs

$${\{ ( {x}_{i} , {y}_{i} ) ∈ {d}^{} \times \}}_{i = 1}^{n} ,$$

which follow the global distribution D. Note that S₁ ∪ . . . ∪S_{N}=[n], and Sᵢ∩Sⱼ=φ. The data of client c is {(xᵢ, yᵢ): i∈S_{c}}, and it follows distribution Dc.

The local update is defined as the weight changes before and after local client training. Consider the local model w_{c}, the local update and global update at t-th round can be expressed as:

$$Δ {w}_{c} ( t ) = {w}_{c} ( t , K ) - {w}_{c} ( t , 0 ) , Δ u ( t ) = u ( t + 1 ) - u ( t ) , \qquad ( 1 )$$

Here, the global update takes the format of aggregation using local updates in practice, i.e., Δu(t)=Σ_{c}p_{c}Δw_{c}(t), where p_{c} denotes the client importance (e.g., proportional to client sample number) and the sum over all clients equals to 1. In FL, a typical paradigm is that each client receives the global update during communication and then use it to update the local model. However, clients may experience covariate shift or concept drift in the real world, i.e., given the joint probability P_{c}(x, y) of input x and label y, P_{c}(x) will vary even if P_{c}(y|x) is the same or P_{c}(x|y) varies across clients while P_{c}(y) is unchanged. Therefore, D does not necessarily represent the actual distribution of a client c's data De well. That is, the global update may not precisely align with the direction of the local update, solely using the global update is not sufficient to minimize the error of each client.

To overcome the potential shift inside the data distribution, one embodiment of the present invention is adapted to perform the PFL by incorporating the local update into the global update to fit Dc. The insight is that the global update contains common knowledge from all clients and conveys global information, while the local update specifically encompasses local information. By mixing local and global updates, the computer system 100 or ASIC is adapted to make the best use of both local and global knowledge to maximize the performance for each client. Specifically, the following update regime for model personalization is considered:

$${w}_{c} ( t + 1 ) ← {w}_{c} ( t ) + {λ}_{c} ( t ) Δ {w}_{c} ( t ) + ( 1 - λ c ( t ) ) Δ u ( t ) , \qquad ( 2 )$$

where λ_{c} is a coefficient of our choice to balance the local and global update. When λ_{c} approaches 0 or 1, the update regime corresponds to the vanilla FedAvg and local gradient descent respectively.

An optimal ratio to mix these two updates is derived in the next step.

### Mixing Ratio Calculation by NTK-Convergence

To find the optimal mixing ratio, the key point is to quantify which update is more important for model optimization. In other words, the optimal mixing should minimize the loss faster than other mixing ratios. Therefore, it is proposed to measure the convergence of using local/global updates and use the convergence rate to determine the mixing ratio. The convergence is measured by using the tool NTK, which has been widely adopted to analyse the convergence of modern neural networks.

To study the convergence of the gradient descent at time step t, the evolution of the error between the ground truth and model prediction at the t-th step can be measured with the help of the Gram matrix H(t). The Gram matrix H(t). is a function of parameter w and input x, which characterizes the optimization process of gradient descent (Du et al., 2019). This Gram matrix is often used as an empirical approximation to the NTK, which describes the dynamics of gradient descent in the infinite wide neural network (Arora et al., 2019a; Lee et al., 2020), and the spectral property of the Gram matrix also governs convergence guarantees for networks in the finite width case (Huang & Yau, 2020; Zhang et al., 2020; Brand et al., 2021). For instance, consider a two-layer neural network with ReLU activation, the H(t). for input data pair xᵢ, xⱼ can be denoted as

$${H ( t )}_{i , j} = \frac{1}{m} {\sum }_{r ∈ [ m ]} ( {x}_{i}^{T} {x}_{j} {{w}_{r} ( t )}^{T} {x}_{i} \geq 0 , {{w}_{r} ( t )}^{T} {x}_{j} \geq 0 ) ,$$

hidden nodes, r is the node index. the footnote c in w is omitted for ease of notation. Intuitively, the Gram matrix captures the correlations between the training samples in the network evolution dynamics. Improving the Du et al. (2019), the evolution of prediction error for one step of gradient descent in one embodiment of the present invention is expressed as:

$$y - y ( t + 1 ) = ( I - η H ( t ) ) ( y - y ( t + 1 ) ) , \qquad ( 3 )$$

where y denotes the label, y(t)=f(w(t), x) and f: [symbol] _{d}→ [symbol] is the model function. Based on Eq. (3), the following observation can be made, which illustrates the significance of between the convergence rate and the trace of the Gram matrix.

Proposition 1. With the assumption that the error vector ξ(t):=y−y(t) can be regarded as a random vector distributed uniformly in the space, by decomposing H(t) and ξ(t) into the eigenbasis of H(t), the prediction error in gradient descent, has an approximate convergence rate of (1−2η tr(H(t))/n), where n is the learning rate and is small, and tr(H(t)) is the trace of H(t).

Proof Sketch: Consider the eigen-decomposition

$$H ( t ) = {\sum }_{i = 1}^{n} {s}_{i} ( t ) {v}_{i} ( t ) {v}_{i}^{T} ( t ) ,$$

$$then$$

$$ξ ( t ) = {\sum }_{i = 1}^{n} ( {v}_{i}^{T} ( t ) ξ ( t ) ) {v}_{i} ( t ) .$$

Then it can derive that

$$ξ ( t + 1 ) = ( I - η H ( t ) ) ξ ( t ) = {\sum }_{i = 1}^{n} ( 1 - η {s}_{i} ) ( {v}_{i}^{T} ( t ) ξ ( t ) ) {v}_{i} ( t ) ,$$

which implies

$${‖ ξ ( t + 1 ) ‖}^{2} = {\sum }_{i = 1}^{n} {( 1 - η {s}_{i} )}^{2} {( {v}_{i}^{T} ( t ) ξ ( t ) )}^{2} .$$

Then for η small and error vector distributed uniformly in space, it follows that ∥ξ(t+1)∥²≈(1−2ηtr(H(t))/n)∥ξ(t)∥². This proposition means that the trace of the Gram matrix can serve as an effective metric for assessing the convergence rate of the model on the data samples. Consequently, the convergence rate can be quantified by leveraging the trace of the H matrix. The Gram matrix of the model obtained through global updates is now denoted as H, and the Gram matrix acquired through local updates as H_{c}. If the convergence rate using local updates surpasses that of global updates, a greater emphasis on local updates becomes necessary. According to the proposition, for the same amount of sample, if tr(Hc)>tr(H), then this means the local update converges more rapidly than the global update. The update with higher convergence rate is given a greater weight in the mixing ratio. To be more specific, for client c at t-th step, the mixing ratio can be calculated as:

$${λ}_{c} ( t ) = tr ( {H}_{c} ( t ) ) / ( tr ( {H}_{c} ( t ) ) + tr ( H ( t ) ) ) . \qquad ( 4 )$$

By taking the ratio back to Eq. (2), the regime to generate the personalized model is completed.

### Algorithm Implementation

In the preceding section, the utilization of the trace of the Gram matrix for determining the mixing ratio is introduced. However, the computation of the Gram matrix H in practical networks poses significant challenges and is often computationally infeasible (Fort et al., 2020; Mohamadi et al., 2023; Holzm\ddot{ }uller et al., 2023). Specifically, the size of the H matrix increases rapidly as the number of samples grows, making the computation impractical, particularly for large datasets. In this case, an approximate of the calculation of tr(H) is conducted in two steps.

First, the significance of the last layer in the dynamics and performance of neural networks should be emphasized. In the approximation, the evolution of the last layer is considered important. For the matrix H,

$$\hat{} {\hat{H} ( t )}_{i , j} := \frac{1}{m} {\sum }_{r ∈ [ m ]} ( {h}_{r} ( {x}_{i} ) {h}_{r} ( {x}_{j} ) )$$

may be used as an approximated representation, where h denotes the parameters up to the penultimate layer. This approximation is also justified by the fact that h, (xᵢ) h, (x) is always a factor of H_{i,j}= [symbol] ∇f_{w}(xᵢ), ∇f_{w}(xⱼ) [symbol] , irrespective of the activation function employed. Here, w is the parameter of the last layer, and f gives the prediction of the whole model. Notably, an existing work (Seleznova et al., 2023) has also shown that the empirical NTK with entries of last-layer features highly aligns with the original NTK in terms of training dynamics. Second, since one objective of the present invention system is to compute the matrix trace, it is unnecessary to calculate the complete H. By leveraging a property of linear algebra, namely, tr(h(x)^{T}h(x))=tr(h(x)h(x)^{T}), the trace calculation can be simplified as follows:

$$tr ( \hat{H} ( t ) ) = \frac{1}{m} {\sum }_{i ∈ [ n ]} {\sum }_{r ∈ [ m ]} {h}_{r} ( {x}_{i} ) {h}_{r} ( {x}_{j} ) = \frac{1}{m} \times tr ( \sum ( t ) ) , \qquad ( 5 )$$

$$where \sum ( t ) = {\sum }_{i = 1}^{n} h ( {x}_{i} ) {h ( {x}_{i} )}^{T}$$

is a feature matrix in [symbol] ^{m×m} considering features among all samples. Note that λ(t) has a size of n×n, while Σ is m×m. As a result, the computational cost is significantly reduced since the number of samples is typically much larger than the last-layer feature dimension (e.g., 256 or 512). With the aforementioned approximation, the trace of the H matrix can be approximated through local updates as tr(H_{c}(t)≈tr(Σ_{c}(t), where

$${\sum }_{c} ( t ) = {\sum }_{i = 1}^{{n}_{c}} {h}_{c} ( {x}_{i} ) {{h}_{c} ( {x}_{i} )}^{T} .$$

In the case of the global H matrix, since the data is distributed and not directly accessible, the features from local data in conjunction with the global model u is applied. Consequently, tr(H(t)) can be approximated as tr(Σ(t)), where

$$\sum ( t ) = {\sum }_{i = 1}^{{n}_{c}} h ( {x}_{i} ) {h ( {x}_{i} )}^{T} .$$

Finally, the mixing ratio for client c at time step t can be calculated as follows:

$${λ}_{c} ( t ) = tr ( {\sum }_{c} ( t ) ) / ( tr ( {\sum }_{c} ( t ) ) + tr ( \sum ( t ) ) ) . \qquad ( 6 )$$

To further stabilize the ratio, one embodiment of the present invention takes into consideration of the history information, that is,

$${λ}_{c} ( t ) = \frac{1}{t - 1} {\sum }_{i = 1}^{t - 1} {λ}_{c} ( i ) .$$

The effects of such stabilization in the experiments of the present invention are shown in later section of the specification.

Algorithm 1: LG-Mix: Local-global updates mixing algorithm

| | Input: | communication rounds T, number of clients N, local update steps K, client learning | | |
|---|---|---|---|---|
| | | $rate {η}_{l} , global learning rate {η}_{g} , mixing ratio {\{ {λ}_{c} \}}_{c = 1}^{N} , feature matrix {\{ {Σ}_{c} \}}_{c = 1}^{N} , Σ .$ | | |
| 1 | for t = 0, 1, . . . , T − 1 do | | | |
| 2 | \| | for c = 1, 2, . . . , N in parallel do | | |
| 3 | \| | \| | for k = 0, 1, . . . , K − 1 do | |
| 4 | \| | \| | \| | sample a batch of data pairs {(xᵢ, yᵢ)}, i ∈ S_{c} |
| 5 | \| | \| | \| | w_{c}(t, k + 1) ← SGD(w_{c}(t, k); {(xᵢ, yᵢ)}) // also output feature h_{c}(xᵢ) |
| 6 | \| | \| | └ | Σ_{c} += h_{c}(xᵢ)h_{c}(xᵢ)^{T}, Σ += h(xᵢ)h(xᵢ)^{T} // update feature matrix |

| 7 | \| | └ | Δw_{c}(t) = w_{c}(t, K) − w_{c}(t, 0) // send client update to server |
|---|---|---|---|
| 8 | \| | u(t + 1) = u(t) + Δu(t), where Δu(t) = Σ_{c}p_{c} Δw_{c}(t) // global model update | |
| 9 | \| | for c = 1, 2, . . . , N in parallel do | |
| 10 | \| | \| | λ_{c}(t) = tr(Σ_{c}(t))/(tr(Σ_{c}(t)) + tr(Σ(t))) // Eq. (6) |
| 11 | └ | └ | w_{c}(t + 1) ← w_{c}(t) + λ_{c}(t)Δw_{c}(t) + (1 − λ_{c}(t))Δu(t) // Eq. (2) |

$Output : The personalized models {\{ {w}_{c} \}}_{c = 1}^{N} , and the global model u .$

### Test-Time Routing for Outside Personalization

With the obtained models during the inside personalization, the personalization on new testing data outside the federation is studied, which is more challenging due to the unseen distribution and unavailable labels. Unfortunately, either directly deploying a single model or a straightforward ensemble of models cannot deliver good performance due to the unseen distributions of the test data. Although current test-time adaptation methods are applicable, they are only for a single model and are mainly restricted to updating a limited subset of parameters. A smart way to utilize multiple models in the personalized FL needs to be proposed. Therefore, based on these internal models, a test-time routing scheme is designed to overcome these challenges. This test-time routing aims to use test data to find optimal re-weight coefficients to aggregate all learnable layers from all models, thus flexibly incorporating both training knowledge and test data information. For outside FL clients, the objective is defined as follows:

$${min}_{{w}_{o} ∈ \tilde{W}} \{ \frac{1}{{n}_{o}} {\sum }_{i = 1}^{{n}_{o}} {ℒ}_{t} ( {f}_{{w}_{o}} ( {x}_{i}^{o} ) ) \} where {x}_{i}^{o} \qquad ( 7 )$$

is the input sampled from the distribution [symbol] ^{o} and nₒ is the number of samples; wₒ is the outside personalized model and \tilde{W}=R·[w₁, . . . , wₙ, u]^{T} is the model weight routing space that incorporates all models obtained after FL training, including the local personalized models and the global model; the R∈ [symbol] ^{L×(N+1)} is the multiplication routing matrix consisting of re-weight coefficient terms

$${r}_{k}^{l}$$

for the l-th layer of the k-th model. All terms in the routing matrix are updated by a specifically designed test-time loss [symbol] ₜ (cf. Eq. 13).

A new personalized model wₒ is derived from all training stage obtained models, the collection of these models is called as well as the corresponding re-weight coefficients as the routing space, which is denoted by \tilde{W}. By minimizing a specifically designed unsupervised loss on the test data from the outside client, these coefficients can be dynamically updated to obtain a new outside personalized model from the routing space. The details for routing space construction and test-time routing are described below.

### Routing Space Construction

To unleash the potential of test-time routing, the routing space is constructed by considering all personalized models as well as the global model. The global model contains strong common knowledge of the general pattern and each personalized model represents its local distribution. By combining these diverse models in the routing space, the representation capacity is largely improved. Furthermore, different from traditional ensemble methods, which simply aggregate outputs at the model level, a layer-wise manner is designed to diversify the feature extraction procedure. For example, for the l-th convolutional layer with parameter

$${W}_{n}^{l}$$

from the n-th model, given sample

$${x}_{i}^{o} ∼ {D}^{o} ,$$

the new weight

$${W}_{o}^{l}$$

can be found from a space that is linearly combined with

$${\{ {W}_{n} \}}_{n = 1}^{N + 1} , where {\{ {W}_{n} \}}_{n = 1}^{N}$$

are layers of inside personalized models and W_{N+1} is the layer from the global model:

$${W}_{o}^{l} \times {x}_{i}^{o} = ( {r}_{1}^{l} \cdot {W}_{1}^{l} + … + {r}_{N + 1}^{l} \cdot {W}_{N + 1}^{l} ) \times {x}_{i}^{o} where {r}_{n}^{l} \qquad ( 8 )$$

is the re-weight coefficient for the linear combination, the test data has been used to dynamically learn the coefficient

$${r}_{n}^{l}$$

for each learnable layer. The coefficients of L-layer models from N clients form the routing matrix R∈ [symbol] ^{L×(N+1)}, i.e., R(n, l) is the re-weight coefficient

$${r}_{n}^{l}$$

for the [symbol] -th layer of the n-th model. all convolutional layers in the neural network has been considered. For the batch normalization layer, since it mainly serves for feature normalization by calculating the mean and variance of features, the mean and variance is directly calculated from the test image feature instead of combining all layers.

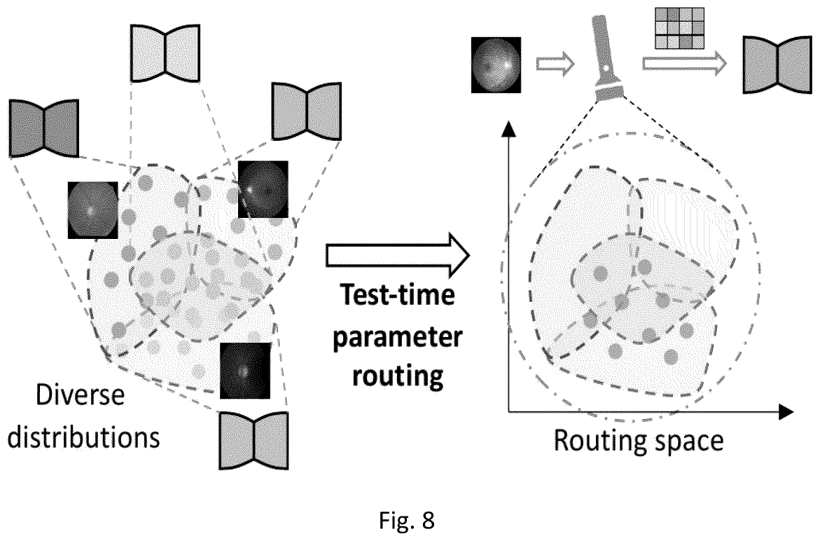

Reference now is made to FIG. 8. The illustration of FIG. 8 is a diagram of test-time parameter routing showing that all trained models contain diverse distribution information. During test-time, the routing process aggregates these varied parameters to better fit the new test data.

As shown in FIG. 8, given all model weights, the routing matrix R is optimized to calculate the outside personalized model weight wₒ from the routing space. Note that R is only optimized but keep existing model weights fixed. The routing matrix R is the core to present the character of the dynamic. Intuitively, given an outside client, the data distribution of this client could be similar to one of the inside clients or lies in their mixed distributions. For the first case, each column vector in the matrix would degrade closely to the one-hot format to fit this similar distribution. For another case, the R coordinates all candidates in the model set to generate better parameters that fit test data distribution as closely as possible. In the following, we will illustrate the design of losses to optimize the coefficients in the routing matrix.

### Test-Time Routing Process

In this section shows how to combine existing models to obtain a high-performance personalized model. The key is to bridge existing models and the desired personalized model via the routing matrix R, where this matrix should be optimized regarding the test data distribution. By denoting ψ as the adaptive average pooling, each coefficient

$${r}_{n}^{l}$$

in R is learnt as follows:

$${r}_{n}^{l} = 1 / ( 1 + exp ( - ψ ( {h}^{l} ) \cdot {θ}_{n}^{l} ) ) \qquad ( 9 )$$

where h^{l} is the input for the l-th layer (for the first layer is the input image and for later layers are feature maps),

$${θ}_{n}^{l}$$

is a multi-layer linear network that maps the pooled inputs to calculate the reweight coefficient. By doing this, each coefficient in the matrix R is determined by the input and the corresponding learnable network

$${θ}_{n}^{l} .$$

the models can be dynamically fused to fit the given data from the outside client by optimizing the routing matrix via the designed losses. In specific, a consistency regularization is designed to capture the input image feature distribution. Given a test image

$${x}_{i}^{o} ,$$

a random Gaussian-like noise

$$ϵ ∼ ( 0 , {( \frac{1}{2} )}^{2} )$$

is generated as a perturbation and added to the image. Denote the output prediction map of

$${x}_{i}^{o} and {x}_{i}^{o} + ϵ$$

as z∈ [symbol] ^{L×H×C} and z′∈ [symbol] ^{L×H×C} respectively, the consistency loss [symbol] _{cons} is defined as below:

$${ℒ}_{c o n s} = \frac{1}{L H} {\sum }_{i = 1}^{L H} {‖ {z}_{i} - {z}_{i}^{′} ‖}_{2}^{2} \qquad ( 10 )$$

Note that this consistency regularization does not need any label information of test data. Furthermore, it is observed that for segmentation tasks, the main source of performance drop at unseen clients is the incomplete shape. Concerning this challenge, a shape-relevant constraint is further proposed to preserve the regular shape of segmentation masks, by making the model predictions within certain limits to be more consistent. Denote

$${V}_{( p , q )}^{c}$$

as the probability vector of the segmentation prediction of class c at the position (p, q) and Q_{(p,q)} as the set of prediction probabilities centered at (p, q). the distance d_{(p,q)} is defined in the following:

$${d}_{( p , q )} = {\sum }_{c} ( {max}_{( {p}^{′} , {q}^{′} ) ∈ {Q}_{( p , q )}} {V}_{( {p}^{′} , {q}^{′} )}^{c} - {min}_{( {p}^{′} , {q}^{′} ) ∈ {Q}_{( p , q )}} {V}_{( {p}^{′} , {q}^{′} )}^{c} ) \qquad ( 11 )$$

where Q_{(p,q)}={(p±l, q±l′)|l, l′∈[d]} and d is a neighbor range radius. an unsupervised shape constraint is designed by minimizing the distance overall prediction probabilities the entropy (uncertainty) of predictions as below:

$${ℒ}_{s} = {\sum }_{( p , q )} {d}_{( p , q )} , {ℒ}_{e} = - {\sum }_{c} {V}_{( p , q )}^{c} log {V}_{( p , q )}^{c} \qquad ( 12 )$$

The shape loss improves the segmentation map with a smoother boundary and the entropy loss reduces prediction uncertainty. Finally, the overall test-time personalization loss [symbol] ₜ is defined as follows:

$${ℒ}_{t} = {ℒ}_{c o n s} ( {x}_{i}^{o} , {x}_{i}^{o} + ϵ ; R ) + β ( {ℒ}_{s} ( {x}_{i}^{o} ; R ) + {ℒ}_{e} ( {x}_{i}^{o} ; R ) ) \qquad ( 13 )$$

where β is a balancing hyper-parameter, R is the routing matrix consisting of learnable weights to be optimized and wₒ is the personalized weights for the outside client. With the complete testtime personalization loss, the routing matrix will be optimized as arg min_{R} [symbol] ₜ. The entire test-time personalization procedure is performed in an unsupervised way and does not affect original training knowledge.

Algorithm: Personalized FL Framework for Inside and Outside Clients

| 1 | Inside personalization | | | |
|---|---|---|---|---|
| | Input | communication rounds T, number of clients N, local update steps K, client learning | | |
| | | $rate {η}_{l} , global learning rate {η}_{g} , mixing ratio {\{ {λ}_{c} \}}_{c = 1}^{N} , feature matrix {\{ {Σ}_{c} \}}_{c = 1}^{N} , Σ .$ | | |
| 2 | for t = 0, 1, . . . , T − 1 do | | | |
| 3 | \| | for c = 1, 2, . . . , N in parallel do | | |
| 4 | \| | \| | for k = 0, 1, . . . , K − 1 do | |
| 5 | \| | \| | \| | sample a batch of data pairs {(xᵢ, yᵢ)}, i ∈ S_{c} |
| 6 | \| | \| | \| | w_{c}(t, k + 1) ← SGD(w_{c}(t, k); {(xᵢ, yᵢ)}) // also output feature h_{c}(xᵢ) |
| 7 | \| | \| | └ | Σ_{c} += h_{c}(xᵢ)h_{c}(xᵢ)^{T}, Σ += h(xᵢ)h(xᵢ)^{T} // update feature matrix |

| 8 | \| | └ | Δw_{c}(t) = w_{c}(t, K) − w_{c}(t, 0) // send client update to server |
|---|---|---|---|
| 9 | \| | u(t + 1) = u(t) + Δu(t), where Δu(t) = Σ_{c}p_{c} Δw_{c}(t) // global model update | |
| 10 | \| | for c = 1, 2, . . . , N in parallel do | |
| 11 | \| | \| | λ_{c}(t) = tr(Σ_{c}(t))/(tr(Σ_{c}(t)) + tr(Σ(t))) // Eq. (6) |
| 12 | └ | └ | w_{c}(t + 1) ← w_{c}(t) + λ_{c}(t)Δw_{c}(t) + (1 − λ_{c}(t))Δu(t) // Eq. (2) |

| | $Output : The personalized models {\{ {w}_{c} \}}_{c = 1}^{N} , and the global model u .$ | |
|---|---|---|
| 13 | Outside personalization | |
| 14 | Initialize R(n, l) = 1/(N + 1) for all n = [N + 1], l = [L], build routing space | |
| | W̅ = R · [w₁, . . . , w_{N}, u]^{T} | |
| 15 | for samples i = 1, . . . , nₒ do | |
| 16 | \| | ${\overline{y}}_{i}^{o} = {f}_{{w}_{o}} ( {x}_{i}^{o} ) model inference$ |
| 17 | └ | R = _{R} [symbol] test-time update, Eq. (13) wₒ = R · [w₁, . . . , w_{N}, u]^{T} |

| | |
|---|---|
| 18 | return wₒ |

### Convergence Analysis

The theorem that describes the convergence of our proposed PFL algorithm can be proved below.

Theorem 1. For m=Ω(λ⁻⁴n⁴ log(n/δ)), randomly initialized parameters (i.e. w(0)˜ [symbol] (0,I)), and ηₗ= [symbol] (λ/κKn²), η_{g}= [symbol] (1), then with probability at least 1−δ over the random initialization, for ∀t:

$${‖ y - y ( t + 1 ) ‖}^{2} \leq {‖ y - y ( t ) ‖}^{2} - ζ {η}_{g} ( 1 - λ ( t ) ) {s}_{min}^{( H )} {‖ y - y ( t ) ‖}^{2} - ζ {\sum }_{c} λ ( t ) {s}_{min}^{( {H}_{c} )} {‖ {y}_{c} - {y}_{c} ( t ) ‖}^{2} ,$$

$$where ζ := \frac{{η}_{l} K}{2 N} ,$$

and sₘᵢₙ denotes the smallest eigenvalue of H matrix.

$$Note that {‖ y - y ( t ) ‖}^{2} = {\sum }_{c} {‖ {y}_{c} - {y}_{c} ( t ) ‖}^{2} , and$$

$$y ( t ) = {( f ( {w}_{1} ( t ) , {x}_{1} ) , … , f ( {w}_{1} ( t ) , {x}_{{n}_{1}} ) , f ( {w}_{2} ( t ) , {x}_{1} ) , … , f ( {w}_{N} ( t ) , {x}_{{n}_{N}} ) )}^{T}$$

$${y}_{c} ( t ) = {( 0 , … , 0 , {\underbrace{f ( {w}_{c} ( t ) , {x}_{1} ) , … , f ( {w}_{c} ( t ) , {x}_{{n}_{c}} )}}_{{x}_{i} ∈ {S}_{c}} , 0 , … , 0 )}^{T}$$

The proof is rather involved including bounding each of the terms in the recursion relation:

$${‖ y - y ( t + 1 ) ‖}^{2} = {‖ y - y ( t ) ‖}^{2} - 2 {( y - y ( t ) )}^{T} ( y ( t + 1 ) - y ( t ) ) + {‖ y ( t + 1 ) - y ( t ) ‖}^{2}$$

The details of the proof to Appendix B.

Discussion on the convergence result. The convergence result is examined by considering the case when Δ is not homogeneous among clients, and a sub-optimal inequality as can be deduced from Appendix B:

$${‖ y - y ( t + 1 ) ‖}^{2} \leq {‖ y - y ( t ) ‖}^{2} - ζ {η}_{g} ( 1 - {λ}_{max} ( t ) ) {s}_{min}^{( H )} {‖ y - y ( t ) ‖}^{2} - ζ {\sum }_{c} {λ}_{c} ( t ) {s}_{min}^{( {H}_{c} )} {‖ {y}_{c} - {y}_{c} ( t ) ‖}^{2}$$

Then by rewriting

$${s}_{min}^{( {H}_{c} )} = {s}_{min}^{( H )} + {δ}_{c} , and {‖ {y}_{c} - {y}_{c} ( t ) ‖}^{2} = \frac{1 + {ϵ}_{c}}{N} {‖ y - y ( t ) ‖}^{2} ,$$

then

$${‖ y - y ( t + 1 ) ‖}^{2} \leq {‖ y - y ( t ) ‖}^{2} - ζ {‖ y - y ( t ) ‖}^{2} [ {η}_{g} ( 1 - {λ}_{max} ( t ) ) {s}_{min}^{( H )} + {\overline{λ}}_{c} {s}_{min}^{( H )} + \frac{1}{N} {\sum }_{c} {λ}_{c} {δ}_{c} ( 1 + {ϵ}_{c} ) ]$$

where λ̅_{c} denotes the average value of {λ_{c}}. With the first two terms in the square bracket being relatively fixed, it is observed that with ϵ_{c}=o(1), larger value of λ_{c} is preferred for larger value of δ_{c}.

### EXPERIMENTAL SETTINGS

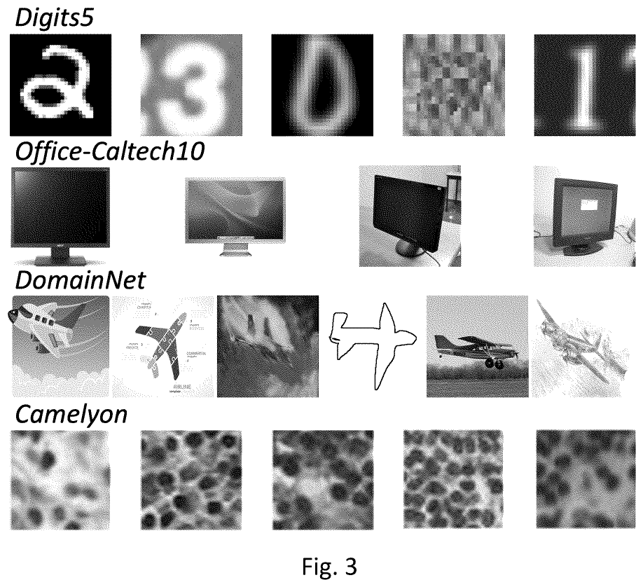

Datasets. The algorithm of an embodiment of the present invention was evaluated on four classification datasets, including (1) Digits-5 (Zhou et al., 2020; Li et al., 2021c) with digits images showing drastic differences in font style, color, and background. (2) Office-Caltech10 (Gong et al., 2012) with images acquired in different cameras or environments; (3) DomainNet (Peng et al., 2019) with different image styles; (4) Camelyon17 (Bandi et al., 2018) with histology images with different stainings from 5 hospitals, and one segmentation task on the Retinal dataset which contains retinal fundus images from 6 different sources (Fumero et al., 2011; Sivaswamy et al., 2015; Almazroa et al., 2018; Orlando et al., 2020). As shown in FIG. 3, each client represents a data source, and data are heterogeneous across clients.

Compared methods and evaluation metrics. The system of an embodiment of the present invention is compared with state-of-the-art (SOTA) PFL methods, including APFL (Deng et al., 2020) and L2SGD (Hanzely et al., 2020) for personalization by mixing local and global models FedAlt (Pillutla et al., 2022) for personalizing partial model layers; PerFedAvg (Fallah et al., 2020) for learning a meta-model that adapts to each client's local data; FedBN (Li et al., 2021c) for personalizing batch normalization layers; FedFomo (Zhang et al., 2021) for aggregating certain client models based on client contribution; FedBABU (Oh et al., 2022) and FedRep (Collins et al., 2021), which propose to personalize the last model layer; FedHKD (Chen et al., 2023) for using knowledge distillation to personalize local models. For evaluation metrics, the accuracy for all classification tasks, and the Dice coefficient (Dice) and Hausdorff Distance (HD) for the segmentation task are reported. All results are reported with mean and standard deviation across three independent runs.

Implementation details. In one implementation of the present invention, all methods use the same training settings. The SGD optimizer is used and applied with a learning rate of 0.01 and CrossEntropy loss is used for classification tasks and Adam optimizer is used and applied with learning rate of 1e⁻³ with β=(0.9, 0.99), dice loss (Milletari et al., 2016) for the segmentation task. For more experimental results and training implementation details, please refer to Appendix. D.

### Performance Comparison Results

The classification performance on four datasets are first presented, which cover the heterogeneous features regarding covariate shift and concept drift. Table 1 and 2 report all results, including each client and the average performance. It can be observed that most PFL methods outperform the common global model learned by FedAvg. As FedBN is specifically designed for heterogeneous features, it presents larger improvements than other methods on most tasks. Interestingly, it is observed that the FedAlt, which personalizes partial layers (i.e., the output layer), also clearly outperforms other PFL methods on most tasks. This may be owing to its alternating update strategy and the importance of the output layer in classification tasks. Compared with all methods, the system of an embodiment of the present invention shows significant improvements on 18 over 20 clients on four datasets, with the largest average performance improvements of 5.01% and least average performance improvements of 0.84%. This demonstrates the effectiveness of our strategy specifically designed by considering the data heterogeneity.

TABLE 1
Performance comparison with SOTA PFL methods on classification
datasets of Digits5 (different strokes and colors) and Office-
Caltech10 (different shapes and view angles).

| | Dataset | | | | | | | | | | |
|---|---|---|---|---|---|---|---|---|---|---|---|
| | Digits5 | | | | | | Office-Caltech10 | | | | |
| | Client | | | | | | | | | | |
| | A | B | C | D | E | Avg. | A | B | C | D | Avg. |
| FedAvg | 98.85 | 89.95 | 95.82 | 99.28 | 88.70 | 94.52 | 78.18 | 56.99 | 51.04 | 61.58 | 61.95 |
| [symbol] | [symbol] | [symbol] | [symbol] | [symbol] | [symbol] | [symbol] | [symbol] | [symbol] | [symbol] | [symbol] | [symbol] |
| APFL | 96.62 | 90.07 | 96.94 | 99.12 | 91.17 | 94.78 | 78.05 | 53.48 | 64.76 | 57.91 | 63.55 |
| [symbol] | [symbol] | [symbol] | [symbol] | [symbol] | [symbol] | [symbol] | [symbol] | [symbol] | [symbol] | [symbol] | [symbol] |
| L2SGD | 98.87 | 89.99 | 96.00 | 99.29 | 88.84 | 94.60 | 78.18 | 56.99 | 51.04 | 68.25 | 63.62 |
| [symbol] | [symbol] | [symbol] | [symbol] | [symbol] | [symbol] | [symbol] | [symbol] | [symbol] | [symbol] | [symbol] | [symbol] |
| FedAlt | 99.20 | 90.51 | 98.26 | 99.32 | 92.36 | 95.93 | 77.31 | 55.95 | 44.79 | 75.14 | 63.30 |
| [symbol] | [symbol] | [symbol] | [symbol] | [symbol] | [symbol] | [symbol] | [symbol] | [symbol] | [symbol] | [symbol] | [symbol] |
| PerFedAvg | 99.05 | 89.55 | 96.11 | 99.23 | 89.53 | 94.69 | 71.73 | 56.55 | 61.46 | 74.01 | 65.94 |
| [symbol] | [symbol] | [symbol] | [symbol] | [symbol] | [symbol] | [symbol] | [symbol] | [symbol] | [symbol] | [symbol] | [symbol] |
| FedBN | 99.22 | 91.48 | 96.20 | 99.32 | 91.14 | 95.47 | 80.10 | 58.18 | 79.17 | 83.05 | 75.13 |
| [symbol] | [symbol] | [symbol] | [symbol] | [symbol] | [symbol] | [symbol] | [symbol] | [symbol] | [symbol] | [symbol] | [symbol] |
| FedFomo | 98.83 | 90.49 | 95.95 | 99.33 | 89.19 | 94.76 | 74.76 | 54.69 | 54.58 | 67.34 | 62.84 |
| [symbol] | [symbol] | [symbol] | [symbol] | [symbol] | [symbol] | [symbol] | [symbol] | [symbol] | [symbol] | [symbol] | [symbol] |
| FedRep | 98.86 | 90.35 | 95.99 | 99.53 | 89.15 | 94.78 | 78.53 | 57.74 | 56.25 | 67.23 | 64.94 |
| [symbol] | [symbol] | [symbol] | [symbol] | [symbol] | [symbol] | [symbol] | [symbol] | [symbol] | [symbol] | [symbol] | [symbol] |
| FedBABU | 98.85 | 90.15 | 95.75 | 99.53 | 88.74 | 94.60 | 77.84 | 57.74 | 56.25 | 67.23 | 64.76 |
| [symbol] | [symbol] | [symbol] | [symbol] | [symbol] | [symbol] | [symbol] | [symbol] | [symbol] | [symbol] | [symbol] | [symbol] |
| FedHKD | 98.11 | 90.38 | 95.41 | 99.47 | 90.06 | 94.69 | 77.14 | 56.52 | 53.98 | 65.48 | 63.28 |
| [symbol] | [symbol] | [symbol] | [symbol] | [symbol] | [symbol] | [symbol] | [symbol] | [symbol] | [symbol] | [symbol] | [symbol] |
| LG-Mix | 99.29 | 92.35 | 98.66 | 99.41 | 95.77 | 97.10 | 80.45 | 56.55 | 86.46 | 93.79 | 79.31 |
| (Ours) | [symbol] | [symbol] | [symbol] | [symbol] | [symbol] | [symbol] | [symbol] | [symbol] | [symbol] | [symbol] | [symbol] |

[symbol]

indicates data missing or illegible when filed

TABLE 2
Performance comparison with SOTA PFL methods on classification datasets
of DomainNet (different styles) and Camelyon17 (different stainings).

| | Dataset | | | | | | | | | | | | |
|---|---|---|---|---|---|---|---|---|---|---|---|---|---|
| | DomainNet | | | | | | | Camelyon17 | | | | | |
| | Client | | | | | | | | | | | | |
| | A | B | C | D | E | F | Avg. | A | B | C | D | E | Avg. |
| FedAvg | 58.17 | 35.06 | 53.61 | 51.97 | 67.05 | 54.15 | 53.34 | 95.44 | 92.20 | 93.96 | 97.21 | 97.71 | 95.30 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| APFL | 58.11 | 36.87 | 53.29 | 46.60 | 69.02 | 58.00 | 53.65 | 96.27 | 92.94 | 96.70 | 97.95 | 98.25 | 96.42 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| L2SGD | 59.00 | 34.60 | 53.88 | 50.33 | 69.82 | 56.02 | 53.94 | 96.67 | 93.02 | 94.71 | 97.55 | 97.68 | 95.93 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| FedAlt | 59.82 | 37.14 | 58.47 | 58.57 | 72.45 | 54.27 | 56.79 | 98.10 | 95.51 | 98.41 | 98.80 | 98.74 | 97.91 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| PerFedAvg | 59.57 | 35.42 | 55.99 | 48.47 | 67.60 | 56.08 | 53.85 | 96.71 | 93.05 | 95.06 | 97.68 | 97.92 | 96.08 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| FedBN | 58.17 | 36.94 | 55.61 | 69.10 | 73.25 | 53.31 | 57.73 | 96.65 | 92.84 | 94.22 | 97.55 | 97.60 | 95.77 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| FedFomo | 59.28 | 36.38 | 56.43 | 49.40 | 69.33 | 57.34 | 54.69 | 96.67 | 92.25 | 95.18 | 97.60 | 96.42 | 95.62 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| FedRep | 60.08 | 36.33 | 56.36 | 47.80 | 67.98 | 58.78 | 54.56 | 97.07 | 93.64 | 96.79 | 98.12 | 98.28 | 96.78 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| FedBABU | 60.71 | 37.14 | 56.26 | 44.63 | 68.50 | 59.12 | 54.40 | 96.69 | 92.93 | 94.30 | 97.53 | 97.41 | 95.77 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| FedHKD | 59.04 | 36.78 | 54.01 | 48.81 | 67.82 | 56.84 | 53.88 | 96.32 | 93.91 | 94.75 | 96.91 | 97.56 | 95.89 |
| [symbol] | [symbol] | [symbol] | [symbol] | [symbol] | [symbol] | [symbol] | [symbol] | [symbol] | [symbol] | [symbol] | [symbol] | [symbol] | [symbol] |
| LG-Mix | 60.84 | 37.20 | 61.49 | 78.07 | 78.62 | 60.23 | 62.74 | 98.77 | 97.98 | 98.93 | 99.13 | 98.95 | 98.75 |
| (Ours) | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

The comparison on the retinal fundus image segmentation is then performed. The fundus image varies with different machines, illumination conditions, field of view, etc. The results are shown in Table. 3. Note that FedBABU, FedRep, and FedHKD are not included because they are specifically designed for classification and suffer a significant performance drop on segmentation. The data from client E (fifth column of Retinal in FIG. 3) shows different appearances due to its different image settings (dual) from others (mono). This scenario further illustrates the necessity of model personalization. Our approach consistently outperforms all compared methods. Specifically, for client E with a unique imaging setting, our method shows very large improvements (15.05%) on Dice compared with the second best, while most PFL methods fail to present a high performance.

TABLE 3
Comparison with SOTA PFL methods on the real-world retinal fundus image segmentation
Retinal Fundus Image Segmentation

| | Client | | | | | | | | | | | | | |
|---|---|---|---|---|---|---|---|---|---|---|---|---|---|---|
| | A | B | C | D | E | F | Avg. | A | B | C | D | E | F | Avg. |
| | Dice Coefficient (Dice) ↑ | | | | | | | Hausdorff Distance (HD) ↓ | | | | | | |
| FedAvg | 83.95 | 83.00 | 81.15 | 87.98 | 67.60 | 91.07 | 82.46 | 7.71 | 4.77 | 8.35 | 4.19 | 68.14 | 2.38 | 15.92 |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| APFL | 74.03 | 72.76 | 70.03 | 81.30 | 66.27 | 90.56 | 75.83 | 27.91 | 52.47 | 43.07 | 18.00 | 76.69 | 5.73 | 37.31 |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| L2SGD | 84.46 | 83.73 | 82.20 | 88.40 | 68.90 | 91.12 | 83.14 | 7.55 | 4.81 | 7.95 | 4.18 | 57.76 | 2.48 | 14.12 |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| FedAlt | 85.01 | 85.19 | 84.06 | 88.98 | 64.48 | 91.05 | 83.13 | 6.20 | 5.07 | 5.25 | 3.59 | 75.60 | 2.58 | 16.38 |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| PerFedAvg | 85.87 | 84.55 | 84.74 | 88.75 | 67.91 | 91.10 | 83.82 | 7.32 | 4.54 | 7.79 | 3.82 | 73.58 | 2.47 | 16.59 |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| FedBN | 84.77 | 83.26 | 83.88 | 88.45 | 67.03 | 91.07 | 83.08 | 7.60 | 4.82 | 5.69 | 2.95 | 63.34 | 2.70 | 14.52 |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| FedFomo | 71.48 | 80.47 | 76.62 | 86.19 | 55.10 | 89.87 | 76.62 | 12.29 | 4.71 | 12.08 | 5.10 | 154.01 | 2.72 | 31.82 |
| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| LG-Mix | 89.25 | 86.76 | 85.86 | 89.79 | 83.95 | 90.86 | 87.75 | 4.43 | 3.63 | 4.53 | 3.57 | 6.38 | 2.34 | 4.15 |
| (Ours) | [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

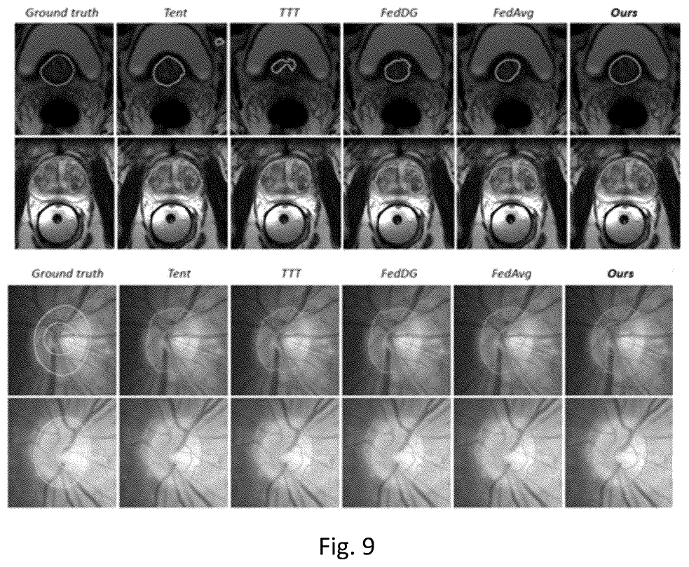

Reference is now made to FIG. 9 which shows a qualitative visualization of segmentation results with the inside-outside personalization method and other state-of-the-art methods. The top three rows are for the prostate MRI segmentation and the bottom two rows for retinal fundus image segmentation

### Analytical Studies

The key properties of the system implemented with the method of an embodiment of the present invention is analyzed, including (a) the personalization weight change during training, (b) why the personalization in an embodiment of the present invention is helpful, (c) the client scalability of the method of the present invention, (d) the distance between the final personalized model and global model, and (e) the effects of considering history personalization weights.

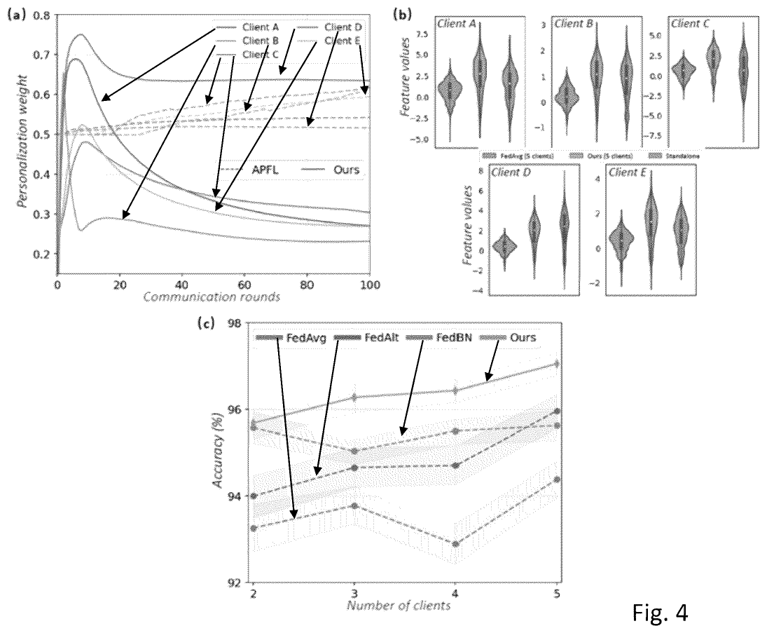

Trend of the personalization weight. The personalization weight with APFL of the present invention is compared, which finds the optimal mixing ratio based on differences between mixed and global models. The weight curves on the Digits5 dataset are presented in FIG. 4(a). APFL tends to mix local and global models evenly (in the range of 0.5-0.6). In contrast, the method of an embodiment of the present invention tends to use more local updates at the beginning and gradually decreases the personalization weight. It finally leads to a stable value. This trend fits the intuition that the global update might be distracted by heterogeneous features and may not be very informative at the early training stage. Client D is always higher than 0.6, it is speculated that client D has more data samples than others, which contribute most to global updates.

Feature value distribution. the feature value distribution is further examined. This helps further validate the quality of the learned personalized model. If a model learns confident representations, then the related neurons should be highly activated Zhou et al. (2018), i.e., the values are higher than the activation criteria (0 for ReLU in the present analysis). The results on five clients from the Digits5 dataset are shown in FIG. 4(b). The analysis shows that the personalized model of the present invention achieves significantly higher feature values than learning a FedAvg global model on heterogeneous features. Moreover, the method of the present invention also outperforms client standalone training on some clients, such as clients A, B, and E. This demonstrates the effectiveness of our method in learning accurate and effective representations by incorporating both local and global knowledge.

Client scalability study. The client scalability analysis on the method of the present invention is carried out by comparing it with the two better-performing methods, FedAlt and FedBN, on the Digits5 dataset. The average test accuracy is reported by increasing the number of training clients, which also results in different training feature distributions. The results are shown in FIG. 4(c), it can be observed that all PFL methods show better scalability than the baseline FedAvg. In particular, our method shows a stable increasing trend with a lower standard deviation among clients (shaded area), while performance improvements of FedBN are saturated by involving more clients, and FedAlt presents an unstable trend with a larger standard deviation.

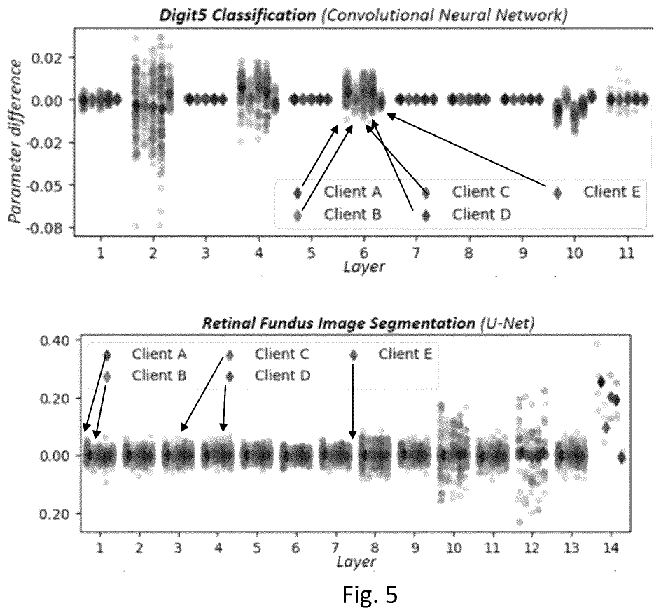

Distance between personalized and global model. The distance between the personalized model and the global model are analysed, in order to investigate how updates mixing reflect in model parameters. Specifically, the differences (i.e., w_{c}−u in layer-wise) of each layer are reported in the classification/segmentation model in FIG. 5. The analysis shows that the output layer varies significantly from the global model in classification, which validates the design of personalizing the classification head in FedBABU, FedRep, and FedAlt. Note that layers 2,4,6,8 are batch normalization layers, which also supports the idea of FedBN. However, the method of the present invention does not specify any target layers but effectively personalizes these important layers identified by other methods. As for the segmentation model, all layers show variance, and the differences become larger in the decoder and output layer. This explains the failure of methods like FedBABU and FedRep, which only personalized the output layer. Overall, the mixing of local and global updates of the present invention can effectively personalize the proper model parameters across all layers.

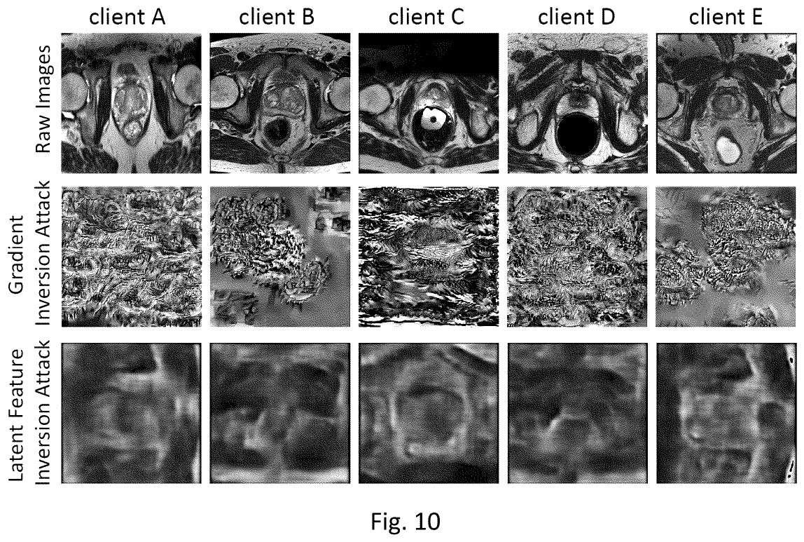

Reference is now made to FIG. 10 which shows a visualization of inversion attacks to reconstruct samples.

Ablation study on using history personalization weights. Ablation studies are conducted to evaluate the effectiveness of the method of the present invention for stabilizing personalization weights. The method of the present invention is compared with the second-best method on each dataset and report the results in Table. 4. The results show that utilizing historical personalization weights improves performance on all classification tasks and has lower standard deviation, which validates the effectiveness of our stabilization strategy.

TABLE 4
Ablation study for effects of stabilizing personalization
weights by considering the history weights.

| | | Office- | | | Retinal |
|---|---|---|---|---|---|
| Task | Digits5 | Caltech10 | DomainNet | Camelyon17 | (Dice) |
| Second | 95.93_{(0.08)} | 75.13_{(1.75)} | 57.73_{(0.69)} | 97.91_{(0.06)} | 83.82_{(0.29)} |
| best | | | | | |
| Ours | 97.10_{(0.05)} | 78.25_{(1.12)} | 60.33_{(2.23)} | 98.70_{(0.13)} | 87.73_{(0.26)} |
| w/o | | | | | |
| history | | | | | |
| Ours | 97.10_{(0.04)} | 79.31_{(1.06)} | 62.74_{(0.12)} | 98.75_{(0.05)} | 87.75_{(0.17)} |

In this specification, a novel approach to address the challenge in PFL for heterogeneous features is disclosed. The method of the present invention mixes local and global updates by measuring the NTK-based convergence during training. Specifically, the trace of NTKs using local/global updates is taken to perform the mixing and approximate the NTK calculation as a feature matrix calculation for computation efficiency. Besides the empirical solutions and significant performance improvements, the convergence rate of our method using NTK are also theoretically analysed. The method of the present invention has no strict restrictions on model architectures and can be applied to a wide range of PFL applications. For future work, it is promising to investigate the effectiveness of our method on other data heterogeneity, such as the class distributional shift, and the larger model, such as the transformer.

### APPENDIX A NOTATION

TABLE 5
Major notations occurred in the paper.

| Notations | Dimension | Description |
|---|---|---|
| k, K | [symbol] | number and total number of local update steps |
| c, N | [symbol] | client index, total number of clients |
| n_{c}, n | [symbol] | number of samples of client c and overall |
| m | [symbol] | number of hidden neurons |
| ηₗ, η_{g} | [symbol] | client-level learning rate, global learning rate |
| w_{c}, u | [symbol] ^{p} | local model of client c, global model |
| (xᵢ, yᵢ) | [symbol] ^{m} | sample pair of index i |
| y_{c}(t), y(t) | [symbol] | model prediction at time t with local model, |
| | | global model |
| S_{c} | set of size n_{c} | collection of samples of client c |

### Appendix B Global Convergence

### B. 1 Formulation

### B.1.1 The Neural Network

For the following theoretical analysis, Du et al. (2019 Song & Yang (2020 Huang et al. (2021) is referred to consider a one-hidden-layer neural network with ReLU activation:

$$f ( u , x ) = \frac{1}{\sqrt{m}} {\sum }_{r = 1}^{m} {a}_{r} ϕ ( {u}_{r}^{T} x )$$

where m is the total number of neurons in the hidden layer, aᵣ 's are Rademacher random variables (take values {±1} with equal probability) and φ is the activation function. Each client aims to optimize its MSE loss:

$${L}_{c}^{m s e} ( u , x ) = \frac{1}{2} {\sum }_{i ∈ {S}_{c}} {( f ( u , {x}_{i} ) - {y}_{i} )}^{2}$$

where S_{c} represents the collection of data of client c. The global loss is taken as the average of the loss of each client:

$$L ( u , x ) = \frac{1}{N} {\sum }_{c ∈ [ N ]} {L}_{c} ( u , x )$$

### b.1.2 the Algorithm

The algorithm is first formulated mathematically to establish consistent notations and facilitate analysis.

In FL, each client alternates between performing local updates on its local data and communicating with the central server for global aggregation. Each client takes K local updates between each communication round. The local update is performed using vanilla gradient descent with a local learning rate ηₗ, and w_{c}(t, k) represents the weight parameters of client c at global round t and local step k:

$${w}_{c} ( t , k + 1 ) ← {w}_{c} ( t , k ) - {η}_{l} \frac{\partial {L}_{c} ( {w}_{c} ( t , k ) )}{\partial {w}_{c} ( t , k )}$$

After each communication, the global aggregation procedure is conducted by taking the average of local updates of all N clients, and a learning rate of ng is added for the global update:

$$Δ u ( t ) = \frac{{η}_{g}}{N} {\sum }_{c ∈ [ N ]} Δ {w}_{c} ( t )$$

$$where Δ {w}_{c} ( t ) = {w}_{c} ( t , K ) - {w}_{c} ( t , 0 ) = - {\sum }_{k} {η}_{l} \frac{\partial {L}_{c} ( {w}_{c} ( t , k ) )}{\partial {w}_{c} ( t , k )}$$

is the cumulative local updates of client c at global round t. For the local step, a combination of local update and global update is taken, with λ(t)∈[0,1] being the combination factor:

$${w}_{c} ( t + 1 , 0 ) ← {w}_{c} ( t , 0 ) + ( 1 - λ ( t ) ) Δ u ( t ) + λ ( t ) Δ {w}_{c} ( t )$$

### B.1.3 Gradient Updates

With the above setting, the gradient updates can be expressed as:

$${Δ}_{{W}_{c , r}} ( t ) = - {\sum }_{k ∈ [ K ]} {η}_{l} \frac{\partial {L}_{c}^{m s e} ( {w}_{c , r} ( t , k ) )}{\partial {w}_{c , r} ( t , k )} = - \frac{{η}_{l}}{\sqrt{m}} {\sum }_{k ∈ [ K ]} {\sum }_{i ∈ {S}_{c}} [ f ( {w}_{c , r} , {x}_{i} ) - {y}_{i} ] {a}_{r} {x}_{i} {{w}_{c , r}^{T} {x}_{i} \geq 0}_{}$$

$$Δ {u}_{r} ( t ) = - \frac{{η}_{l} {η}_{g}}{N \sqrt{m}} {\sum }_{c ∈ [ N ]} {\sum }_{k ∈ [ K ]} {\sum }_{i ∈ {S}_{c}} [ f ( {w}_{c , r} ( t , k ) , {x}_{i} ) - {y}_{i} ] {a}_{r} {x}_{i} {{w}_{c , r}^{T} {x}_{i} \geq 0}_{}$$

### B. 2 Convergence Analysis

The convergence behavior of all clients is collectively analyzed. That is, the dynamics of ∥y−y(t)∥²=Σ_{c}∥y_{c}−y_{c}(t)∥² is considered, where

$$y ( t ) = {( f ( {w}_{1} ( t ) , {x}_{1} ) , … , f ( {w}_{1} ( t ) , {x}_{{n}_{1}} ) , f ( {w}_{2} ( t ) , {x}_{1} ) , … , f ( {w}_{N} ( t ) , {x}_{{n}_{N}} ) )}^{T}$$

$${y}_{c} ( t ) = {( 0 , … , 0 , {\underbrace{f ( {w}_{c} ( t ) , {x}_{1} ) , … , f ( {w}_{c} ( t ) , {x}_{{n}_{c}} )}}_{{x}_{i} ∈ {S}_{c}} , 0 , … , 0 )}^{T}$$

are the stacked vector of predictions and y, y_{c} are the corresponding ground truth. Note first the following recurrence relation (†):

$$\begin{matrix}{‖ y = y ( t + 1 ) ‖}^{2} = {‖ [ y - y ( t ) ] - [ y ( t + 1 ) - y ( t ) ] ‖}^{2} \\ = {‖ y - y ( t ) ‖}^{2} - 2 {( y - y ( t ) )}^{T} ( y ( t + 1 ) - \\ y ( t ) ) + {‖ y ( t + 1 ) - y ( t ) ‖}^{2} \\ = {‖ y - y ( t ) ‖}^{2} - 2 {\underbrace{{\sum }_{c} {( {y}_{c} - {y}_{c} ( t ) )}^{T} ( {y}_{c} ( t + 1 ) - {y}_{c} ( t ) )}}_{the cross term} + \\ {‖ y ( t + 1 ) - y ( t ) ‖}^{2}\end{matrix}$$

This term ∥y−y(t+1)∥² can be expressed in terms of ∥y−y(t)∥² with a shrinking factor, by bounding each of these terms, and hence prove the convergence of the algorithm.

### B.2.1 the Cross Term

The cross term is then examined. Note that the difficulty in the analysis mainly comes from the non-linear activation pattern. However, this is overcome by a key observation in classical NTK theory Du et al. (2019) Huang et al. (2021) that the activation patterns stay the same for most of the neurons.

One approach taken in the method of the present invention is defined as:

$${Q}_{i} := \{ r ∈ [ m ] : ∀ m ∈ {d}^{} s . t . {‖ w - {w}_{r} ( 0 ) ‖}_{2} \leq R , {{{w}_{r} ( 0 )}^{T} {x}_{i} \geq 0}_{} = {{w}^{T} {x}_{i} \geq 0}_{} \}$$

which represents the set of neurons whose activation pattern does not change during training for sample xᵢ, and let Q̅ᵢ denote its complement. Then for each sample i∈S_{c},

$$\begin{matrix}{y}_{i} ( t + 1 ) - {y}_{i} ( t ) = \frac{1}{\sqrt{m}} {\sum }_{r ∈ [ m ]} {a}_{r} [ ϕ ( {w}_{r}^{T} ( t + 1 ) {x}_{i} ) - ϕ ( {w}_{r}^{T} ( t ) {x}_{i} ) ] \\ = {\underbrace{\frac{1}{\sqrt{m}} {\sum }_{r ∈ {Q}_{i}} {a}_{r} ( 1 - {λ}_{c} ( t ) ) Δ {u}_{r}^{T} ( t ) {x}_{i} {𝕝}_{{w}_{r}^{T} ( t ) {x}_{i} \geq 0}}}_{{v}_{2 , i}} + \\ {\underbrace{\frac{1}{\sqrt{m}} {\sum }_{r ∈ {Q}_{i}} {a}_{r} {λ}_{c} ( t ) Δ {w}_{c , r}^{T} ( t ) {x}_{i} {𝕝}_{{w}_{r}^{T} ( t ) {x}_{i} \geq 0}}}_{{v}_{2 , i}} + {v}_{3 , i}\end{matrix} where$$

$${v}_{1 , i} = - \frac{( 1 - {λ}_{c} ( t ) ) {η}_{l} {η}_{g}}{Nm} {\sum }_{k ∈ [ K ] , r ∈ {Q}_{i}} {\sum }_{j ∈ {S}_{c}^{′} , {c}^{′} ∈ [ N ]} ( {y ( t , k )}_{j} - {y}_{j} ) {x}_{i}^{T} {x}_{j} {𝕝}_{{w}_{{c}^{′} , r}^{T} ( t , k ) {x}_{j} \geq 0 , {w}_{c , r}^{T} ( t ) {x}_{i} \geq 0}$$

$${v}_{2 , i} = - \frac{{λ}_{c} ( t ) {η}_{l}}{m} {\sum }_{k ∈ [ K ] , r ∈ {Q}_{i}} {\sum }_{j ∈ {S}_{c}} ( {{y}_{c} ( y , k )}_{j} - {y}_{c , j} ) {x}_{i}^{T} {x}_{j} {𝕝}_{{w}_{c , r}^{T} ( t , k ) {x}_{j} \geq 0 , {w}_{r}^{T} ( t ) {x}_{i} \geq 0}$$

$${v}_{3 , i} = \frac{1}{\sqrt{m}} {\sum }_{r ∉ {Q}_{i}} {a}_{r} [ ϕ ( {w}_{r}^{T} ( t + 1 ) {x}_{i} ) - ϕ ( {w}_{r}^{T} ( t ) {x}_{i} ) ]$$

It is noticed that the almost symmetric kernel factor in the terms above. The formal definition is given here below.

Definition 1 (Global Gram matrix). For t∈[T], k∈[K], c,c′∈[N], i∈S_{c} and j∈S_{c}′, the global gram matrix is defined as.

$${H ( t , k )}_{i , j} : = \frac{1}{m} {\sum }_{r ∈ [ m ]} {x}_{i}^{T} {x}_{j} {𝕝}_{{w}_{c , r}^{T} ( t ) {x}_{i} \geq 0 , {w}_{{c}^{′} , r}^{T} ( t , k ) {x}_{j} \geq 0} ∈ {ℝ}^{n \times n}$$

$${H ( t , k )}_{i , j}^{⊥} : = \frac{1}{m} {\sum }_{r ∉ {Q}_{i}} {x}_{i}^{T} {x}_{j} {𝕝}_{{w}_{c , r}^{T} ( t ) {x}_{i} \geq 0 , {w}_{{c}^{′} , r}^{T} ( t , k ) {x}_{j} \geq 0} ∈ {ℝ}^{n \times n}$$

Note that this definition is similar to, but not exactly the same as, the definition in FL-NTK Huang et al. (2021). This is because they considered the vanilla FedAvg with no personalization of model parameters.

Definition 2 (Local Gram matrix). For t∈[T], k∈[K], c∈[N] and i,j∈S_{c}′, the local gram matrix is defined as:

$${{H}_{c} ( t , k )}_{i , j} = \frac{1}{m} {\sum }_{r} {x}_{i}^{T} {x}_{j} {𝕝}_{{w}_{c , r}^{T} ( t ) {x}_{i} \geq 0 , {w}_{c , r}^{T} ( t , k ) {x}_{j} \geq 0} ∈ {ℝ}^{{n}_{c} \times {n}_{c}}$$

$${{H}_{c} ( t , k )}_{i , j}^{⊥} = \frac{1}{m} {\sum }_{r ∉ {Q}_{i}} {x}_{i}^{T} {x}_{i} {𝕝}_{{w}_{c , r}^{T} ( t ) {x}_{i} \geq 0 , {w}_{c , r}^{T} ( t , k ) {x}_{j} \geq 0} ∈ {ℝ}^{{n}_{c} \times {n}_{c}}$$

However, in order to maintain consistent dimensions and correspond to the definition of y_{c}, the dimension of He can be extended to n×n by adding zeros to the undefined entries, i.e.,

$$( \begin{matrix}0 & ⋯ & 0 \\ ⋮ & {H}_{c} & ⋮ \\ 0 & ⋯ & 0\end{matrix} ) ∈ {ℝ}^{n \times n}$$

From then on, the symbol Hc will refer to this n×n matrix. Note that (H_{c})_{i,j}=H_{i,j} [symbol] _{i,j∈S}_{_{c}}.

It can be shown that the convergence can be governed by the spectral property of these Gram matrices. Substitute them into the cross term, it follows that:

$${\sum }_{c} {( {y}_{c} - {y}_{c} ( t ) )}^{T} ( {y}_{c} ( t + 1 ) - {y}_{c} ( t ) ) ) = {\sum }_{c} \frac{( 1 - {λ}_{c} ) {η}_{l} {η}_{g}}{N} {\sum }_{i ∈ {S}_{c}} ( {y}_{c , i} - {{y}_{c} ( t )}_{i} ) {\sum }_{k ∈ [ K ] , j ∈ [ n ]} ( {y ( t , k )}_{j} - {y}_{j} ) ( {H ( t , k )}_{i , j} - {H ( t , k )}_{i , j}^{⊥} ) + {\sum }_{c} {λ}_{c} {η}_{l} {\sum }_{i ∈ {S}_{c}} ( {y}_{c , i} - {{y}_{c} ( t )}_{i} ) {\sum }_{k ∈ [ K ] , j ∈ {S}_{c}} ( {{y}_{c} ( t , k )}_{j} - {y}_{c , j} ) ( {{H}_{c} ( t , k )}_{i , j} - {{H}_{c} ( t , k )}_{i , j}^{⊥} ) - {\sum }_{c} {\sum }_{i ∈ {S}_{c}} ( {y}_{c , i} - {{y}_{c} ( t )}_{i} ) {v}_{3 , i}$$

$$Let {C}_{1} : = - {\sum }_{c} \frac{( 1 - {λ}_{c} ( t ) ) {η}_{l} {η}_{g}}{N} {\sum }_{i ∈ {S}_{c}} ( {y}_{c , i} - {{y}_{c} ( t )}_{i} ) {\sum }_{k , j} ( {y ( t , k )}_{j} - {y}_{j} ) ( {H ( t , k )}_{i , j} - {H ( t , k )}_{i , j}^{⊥} )$$

$${C}_{2}^{( c )} : = - {λ}_{c} ( t ) {η}_{l} {\sum }_{i ∈ {S}_{c}} ( {y}_{c , i} - {{y}_{c} ( t )}_{i} ) {\sum }_{k , j ∈ {S}_{c}} ( {{y}_{c} ( t , k )}_{j} - {y}_{c , j} ) ( {{H}_{c} ( t , k )}_{i , j} - {{H}_{c} ( t , k )}_{i , j}^{⊥} )$$

$${C}_{2} : = {\sum }_{c} {C}_{2}^{( c )}$$

$${C}_{3} : = - {\sum }_{c} {\sum }_{i ∈ {S}_{c}} ( {y}_{c , i} - {{y}_{c} ( t )}_{i} ) {ν}_{3 , i}$$

Then by substituting them back into the recursive relation (†), it follows that:

$${‖ y - y ( t + 1 ) ‖}^{2} = {‖ y - y ( t ) ‖}^{2} + 2 ( {C}_{1} + {C}_{2} + {C}_{3} ) + {‖ y ( t + 1 ) - y ( t ) ‖}^{2}$$

Each of these terms is bounded and hence proves the result.

### B. 3 Convergence Analysis-Main Theorem

The main convergence theorem is now restated.

Theorem 1. For uniform λ_{c}(t)=λ(t), ∀c, for m=Ω(λ⁻⁴n⁴ log(n/δ)), randomly initialized parameters (i.e. w(0)˜ [symbol] (0,I), and ηₗ= [symbol] (λ/κKn²), η_{g}= [symbol] (1), then with probability at least 1−δ over the random initialization, it follows that for Vt:

$${‖ y - y ( t + 1 ) ‖}^{2} \leq {‖ y - y ( t ) ‖}^{2} - ζ {η}_{g} ( 1 - λ ( t ) ) {s}_{m i n}^{( H )} {‖ y - y ( t ) ‖}^{2} - ζ {\sum }_{c} λ ( t ) {s}_{m i n}^{( {H}_{c} )} {‖ {y}_{c} - {y}_{c} ( t ) ‖}^{2}$$

$$where ζ := \frac{{η}_{l} K}{2 N} .$$

Theorem 2. For non-uniform λ_{c}(t), let λₘᵢₙ(t):=min_{c}λ_{c}(t) and λₘₐₓ(t):=max_{c}λ_{c}(t), For m=Ω(λ⁻⁴n⁴ log(n/δ)), randomly initialized parameters (i.e. w(0)˜ [symbol] (0,I)), and ηₗ= [symbol] (λ/κKn²), η_{g}= [symbol] (1), then with probability at least 1−δ over the random initialization, it follows that for ∀t:

$${‖ y - y ( t + 1 ) ‖}^{2} \leq {‖ y - y ( t ) ‖}^{2} - {ζη}_{g} ( 1 - {λ}_{m ax} ( t ) ) {s}_{m i n}^{( H )} K ‖ y - y ( t ) - ζ {\sum }_{c} {λ}_{m i n} ( t ) {s}_{m i n}^{( {H}_{c} )} {‖ {y}_{c} - {y}_{c} ( t ) ‖}^{2}$$

$$where ζ := \frac{{η}_{1} K}{2 N} .$$

The proof of theorem 1 will be provided in the subsequent sections, and it is noted that theorem 2 is a natural extension of theorem 1 so the proof also naturally extends.

### B. 4 Useful Lemmas

Before giving the proof of the theorem, two useful lemmas are first provided.

The first lemma gives bounds on the norm of the local and global updates.

Lemma 1. With ∥xₗ∥₂=1, it follows that:

$${‖ Δ {u}_{r} ( t ) ‖}_{2} \leq \frac{2 {η}_{l} {η}_{g} K ( 1 + 2 {η}_{l} n K ) \sqrt{n}}{N \sqrt{m}} {‖ y - y ( t ) ‖}_{2}$$

$${‖ Δ {w}_{r}^{( c )} ( t ) ‖}_{2} \leq \frac{2 {η}_{l} K ( 1 + 2 {η}_{l} {n}_{c} K ) \sqrt{{n}_{c}}}{\sqrt{m}} {‖ {y}_{c} - {y}_{c} ( t ) ‖}_{2}$$

Proof. The first inequality follows from FL-NTK. For the second inequality, consider:

$${‖ Δ {w}_{r}^{( c )} ( t ) ‖}_{2} = {η}_{l} ‖ \frac{{a}_{r}}{\sqrt{m}} {\sum }_{k ∈ [ K ]} {\sum }_{i ∈ {S}_{c}} [ {y ( t , k )}_{l} - {y}_{l} ] {x}_{i} {𝕝}_{{w}_{k , c}^{T} {x}_{i} \geq 0} ‖ \leq \frac{{η}_{l}}{\sqrt{m}} {\sum }_{k ∈ [ K ]} {\sum }_{i ∈ {S}_{c}} [ {y}_{i} - {y ( t , k )}_{i} ] \leq \frac{{η}_{l} \sqrt{{n}_{c}}}{\sqrt{m}} {\sum }_{k ∈ [ K ]} ‖ {y}_{c} - {y}_{c} ( t , k ) ‖ \leq \frac{{η}_{l} K ( 1 + 2 {η}_{l} {η}_{c} K ) \sqrt{{n}_{c}}}{\sqrt{m}} {‖ {y}_{c} - {y}_{c} ( t ) ‖}_{2}$$

The second lemma bounds the sum of client prediction error by that of the global error.

### Lemma 2.

$${\sum }_{c} ‖ {y}_{c} - {y}_{c} ( t ) ‖ \leq \sqrt{N} ‖ y - y ( t ) ‖$$

Proof. By Jensen's inequality, and since the square root function is concave,

$$\sqrt{\frac{1}{N} {\sum }_{c} {‖ {y}_{c} - {y}_{c} ( t ) ‖}^{2}} \geq \frac{1}{N} {\sum }_{c} ‖ {y}_{c} - {y}_{c} ( t ) ‖$$

### B. 5 Proof of Theorem 1

Here is provided a detailed proof of theorem 1, and it is noted that the same proof naturally extends to prove theorem 2 The term λ is used to represent λ(t) for ease of notation.

Firstly, here are two results that directly follow from FL-NTK. They provide bounds on the effect of global and local updates respectively.

Proposition 2. With probability at least 1−nexp(−mR) over random initialization, it follows that:

$${C}_{1} \leq \frac{{η}_{l} {η}_{g} ( 1 - λ )}{N} {‖ y - y ( t ) ‖}^{2} ( - K {s}_{m i n}^{( H )} + 40 \sqrt{n} R K ( 1 + 2 {η}_{l} K \sqrt{n} ) + 2 {η}_{l} {s}_{m ax}^{( H )} {K}^{2} \sqrt{n} ) ) + \frac{8 {η}_{g} {η}_{l} ( 1 - λ )}{N} K ( 1 + 2 {η}_{l} n K ) nR {‖ y - y ( t ) ‖}^{2}$$

Proposition 3. With probability at least 1−nexp(−mR) over random initialization, it follows that:

$${C}_{2}^{( c )} \leq \frac{λ {η}_{l}}{N} {‖ {y}_{c} - {y}_{c} ( t ) ‖}^{2} ( - {Ks}_{m i n}^{( {H}_{c} )} + 40 \sqrt{n} R K ( 1 + 2 {η}_{l} K \sqrt{n} + 2 {η}_{l} {s}_{m ax}^{( {H}_{c} )} {K}^{2} \sqrt{n} ) ) + \frac{8 λ {η}_{l}}{N} K ( 1 + 2 {η}_{l} n K ) nR {‖ {y}_{c} - {y}_{c} ( t ) ‖}^{2}$$

For the following two propositions, it is assumed that all clients possess the same number of samples, i.e., n_{c}=n/N, ∀c. Additionally, let \tilde{η}_{g} denote max {1, η_{g}}.

The following proposition aims to bound the effect of updates on neurons whose activation pattern changed during the algorithm.

Proposition 4. With probability at least 1−nexp(−mR) over random initialization, it follows that:

$${C}_{3} \leq \frac{8 {η}_{l} {\tilde{η}}_{g} K}{N} ( 1 + 2 {η}_{l} n K ) nR {‖ y - y ( t ) ‖}^{2}$$

$$Proof . Consider {‖ {v}_{3} ‖}_{2}^{2} \leq {\underbrace{\frac{1 - λ}{m} {\sum }_{i ∈ [ n ]} {( {\sum }_{r ∈ {\overline{Q}}_{i}} \vert Δ {{u}_{r} ( t )}^{T} {x}_{i} \vert )}^{2}}}_{A} + {\underbrace{\frac{λ}{m} {\sum }_{i ∈ [ n ]} {( {\sum }_{r ∈ {\overline{Q}}_{i}} \vert Δ {{w}_{r} ( t )}^{T} {x}_{i} \vert )}^{2}}}_{B}$$

$$and A \leq {( \frac{8 ( 1 - λ ) {η}_{g} {η}_{l} K}{N} ( 1 + 2 {η}_{l} n K ) nR ‖ y - y ( t ) ‖ )}^{2}$$

### As for B,

$$\begin{matrix}B = \frac{λ}{m} {\sum }_{c} {\sum }_{i ∈ {S}_{c}} {( {\sum }_{r ∈ [ m ]} {𝕀}_{r ∈ {\overline{Q}}_{i}} \vert Δ {{u}_{r} ( t )}^{T} {x}_{i} \vert )}^{2} \\ \leq \frac{{λη}_{l}^{2}}{m} {\sum }_{c} \frac{4 {{K}^{2} ( 1 + 2 {η}_{l} {n}_{c} K )}^{2} {n}_{c}}{m} {‖ {y}_{c} - {y}_{c} ( t ) ‖}^{2} \cdot {{n}_{c} ( 4 mR )}^{2} \\ \leq {( \frac{8 {λη}_{l} K}{N} ( 1 + 2 {η}_{l} nK ) nR ‖ y - y ( t ) ‖ )}^{2}\end{matrix}$$

where for the second inequality the assumption made above is applied. Then

$$\begin{matrix}{C}_{3} := - {\sum }_{i ∈ [ n ]} ( {y}_{i} - {y}_{i} ( t ) ) {v}_{3 , i} \\ \leq {‖ y - y ( t ) ‖}_{2} {‖ {v}_{3} ‖}_{2} \\ \leq \frac{8 {η}_{l} {\tilde{η}}_{g} K}{N} ( 1 + 2 {η}_{l} nK ) nR {‖ y - y ( t ) ‖}^{2}\end{matrix}$$

Now x the cross team is bounded. For the last term, there is provided the following inequality:
Proposition 5. There is provided:

$${‖ y ( t + 1 ) - y ( t ) ‖}^{2} \leq \frac{4 {η}_{l}^{2} {\tilde{η}}_{g}^{2} {n}^{2} {{K}^{2} ( 1 + 2 {η}_{l} nK )}^{2}}{{N}^{2}} {‖ y - y ( t ) ‖}^{2}$$

$$Proof .$$

$$\begin{matrix}{‖ y ( t + 1 ) - y ( t ) ‖}^{2} \leq \frac{1 - λ}{m} {\sum }_{t ∈ [ n ]} {( {\sum }_{r ∈ [ m ]} \vert Δ {{u}_{r} ( t )}^{T} {x}_{i} \vert )}^{2} + \frac{λ}{m} {\sum }_{i ∈ [ n ]} {( {\sum }_{r ∈ [ m ]} \vert Δ {{w}_{r} ( t )}^{T} {x}_{i} \vert )}^{2} \\ \leq \frac{( 1 - λ ) {η}_{g}^{2} {η}_{l}^{2}}{m} {( \frac{2 K ( 1 + 2 {η}_{l} nK ) \sqrt{n}}{N \sqrt{m}} ‖ y - y ( t ) ‖ )}^{2} \cdot {nm}^{2} \\ + {\sum }_{c} \frac{{λη}_{l}^{2}}{m} {( \frac{2 K ( 1 + 2 {η}_{l} {η}_{c} K ) \sqrt{{n}_{c}}}{\sqrt{m}} ‖ {y}_{c} - {y}_{c} ( t ) ‖ )}^{2} \cdot {n}_{c} {m}^{2} \\ \leq \frac{4 {η}_{l}^{2} {\tilde{η}}_{g}^{2} {n}^{2} {{K}^{2} ( 1 + 2 {η}_{l} nK )}^{2}}{{N}^{2}} {‖ y - y ( t ) ‖}^{2}\end{matrix}$$

where the assumption that n_{c}=n/N is applied.

Now by substituting the above results to the recursion equation, it follows that:

$${‖ y - y ( t + 1 ) ‖}^{2} \leq {‖ y - y ( t ) ‖}^{2} +$$

$$\frac{2 {η}_{l} {η}_{g} ( 1 - λ )}{N} {‖ y - y ( t ) ‖}^{2} ( - {Ks}_{min}^{( H )} +$$

$$40 \sqrt{n} RK ( 1 + 2 {η}_{l} K \sqrt{n} ) + 2 {η}_{l} {s}_{max}^{( H )} {K}^{2} \sqrt{n} ) ) + \frac{16 {η}_{g} {η}_{l} ( 1 - λ )}{N} K ( 1 +$$

$$2 {η}_{l} nK ) nR {‖ y - y ( t ) ‖}^{2} {\sum }_{c} \frac{2 {λη}_{l}}{N} {‖ {y}_{c} - {y}_{c} ( t ) ‖}^{2} ( - {Ks}_{min}^{( {H}_{c} )} +$$

$$40 \sqrt{n} RK ( 1 + 2 {η}_{l} K \sqrt{n} 2 {η}_{l} {s}_{max}^{( {H}_{c} )} {K}^{2} \sqrt{n} ) ) + \frac{16 {λη}_{l}}{N} K ( 1 +$$

$$2 {η}_{l} nK ) nR {\sum }_{c} {‖ {y}_{c} - {y}_{c} ( t ) ‖}^{2} \frac{16 {η}_{l} {\tilde{η}}_{g} K}{N} ( 1 + 2 {η}_{l} nK ) nR {‖ y - y ( t ) ‖}^{2} +$$

$$\frac{4 {η}_{l}^{2} {\tilde{η}}_{g}^{2} {n}^{2} {{K}^{2} ( 1 + 2 {η}_{l} nK )}^{2}}{{N}^{2}} {‖ y - y ( t ) ‖}^{2}$$

Then by the choice of

$${η}_{l} \leq min \{ \frac{{s}_{min}^{( H )}}{1000 κ {n}^{2} K} , {min}_{c} \{ \frac{{s}_{min}^{( {H}_{c} )}}{1000 {κ}_{c} {n}^{2} K} \} \}$$

$$where$$

$$κ := {s}_{max} / {s}_{min} and {η}_{l} {η}_{g} \leq min \{ \frac{{s}_{min}^{( H )}}{1000 κ {n}^{2} K} , {min}_{c} \{ \frac{{s}_{min}^{( {H}_{c} )}}{1000 {κ}_{c} {n}^{2} K} \} \} and R \leq {s}_{min}^{( H )} / ( 1 \; 000 n ) ,$$

it follows that

$$\begin{matrix}{‖ y - y ( t + 1 ) ‖}^{2} \leq {‖ y - y ( t ) ‖}^{2} \\ - \frac{( 1 - λ ) {η}_{l} {η}_{g} {s}_{min}^{( H )} K}{N} {‖ y - y ( t ) ‖}^{2} - {\sum }_{c} \frac{{λη}_{l} {s}_{min}^{( {H}_{c} )} K}{N} {‖ {y}_{c} - {y}_{c} ( t ) ‖}^{2} \\ + 40 \frac{{η}_{l} {η}_{g} K nR}{N} {‖ y - y ( t ) ‖}^{2} \times 2 \\ + \frac{{η}_{l}^{2} {\tilde{η}}_{g}^{2} {n}^{2} {K}^{2}}{{N}^{2}} {‖ y - y ( t ) ‖}^{2} \\ \leq {‖ y - y ( t ) ‖}^{2} - \frac{( 1 - λ ( t ) ) {η}_{l} {η}_{g} {s}_{min}^{( H )} K}{2 N} {‖ y - y ( t ) ‖}^{2} \\ - {\sum }_{c} \frac{λ ( t ) {η}_{l} {s}_{min}^{( {H}_{c} )} K}{2 N} {‖ {y}_{c} - {y}_{c} ( t ) ‖}^{2}\end{matrix}$$

by substituting in the condition on ηₗ and R.
Quod erat demonstrandum.

### APPENDIX C GENERALIZATION

In this section, there is proved a proof for the generalization bounds. The aim is to find a bound on

$${ℒ}_{𝒟} ( f ) := {( x , y ) \sim D}_{} [ l ( f ( x ) , y ) ]$$

where f refer to the prediction function. Note that, in practice, this is approximated by the empirical loss

$${L}_{S} ( f ) = \frac{1}{n} {\sum }_{i ∈ [ n ]} l ( f ( {x}_{i} ) , {y}_{i} ) .$$

A more general initialization scheme wᵣ˜ [symbol] (0,σ²I) may be considered.

### C.1 Setup

In one embodiment, a non-degenerate data distribution is set up and examined.

Definition 3 (Non-degenerate Data Distribution). A distribution [symbol] over [symbol] ^{b}× [symbol] is (λ, δ, n)-nondegenerate, if with probability at least 1−δ, for n iid samples

$${\{ ( {x}_{i} , {y}_{i} ) \}}_{i = 1}^{n}$$

chosen from [symbol] ,

$${s}_{min}^{( {H}^{∞} )} \geq s > 0 .$$

It is also stated here the definition of the dynamic matrices which can be used to describe the evolution of the neural network:

### Definition 4 (Global Trajectory Matrix).

$$J ( t , k ) = \frac{1}{\sqrt{m}} ( \begin{matrix}{a}_{1} {x}_{1} {{w}_{{c}_{1} , 1}^{T} ( t , k ) {x}_{1} \geq 0}_{} & ⋯ & {a}_{1} {x}_{1} {{w}_{{c}_{n} , 1}^{T} ( t , k ) {x}_{n} \geq 0}_{} \\ ⋮ & ⋱ & ⋮ \\ {a}_{m} {x}_{1} {{w}_{{c}_{1} , m}^{T}}_{} ( t , k ) {x}_{1} \geq 0 & ⋯ & {a}_{m} {x}_{n} {{w}_{{c}_{n} , m}^{T} ( t , k ) {x}_{n} \geq 0}_{}\end{matrix} ) ∈ {md \times n}^{}$$

### Definition 5 (Local Trajectory Matrix).

$${J}_{c} ( t , k ) = \frac{1}{\sqrt{m}} ( \begin{matrix}{a}_{1} {x}_{1} {{w}_{{c}_{1} , 1}^{T} ( t , k ) {x}_{1} \geq 0}_{} & ⋯ & {a}_{1} {x}_{{n}_{c}} {{w}_{{c}_{{n}_{c}} , 1}^{T} ( t , k ) {x}_{{n}_{c}} \geq 0}_{} \\ ⋮ & ⋱ & ⋮ \\ {a}_{m} {x}_{1} {{w}_{{c}_{1} , m}^{T}}_{} ( t , k ) {x}_{1} \geq 0 & ⋯ & {a}_{m} {x}_{{n}_{c}} {{w}_{{c}_{{n}_{c}} , m}^{T}}_{} ( t , k ) {x}_{{n}_{c}} \geq 0\end{matrix} ) ∈ {md \times {n}_{c}}^{}$$

for xᵢ's sample of client c, and where appropriate, the undefined entries are filled in with 0 to form a matrix of dimension md×n.

Note that H=J^{T}J and

$${H}_{c} = {J}_{c}^{T} {J}_{c} .$$

It also gives some useful notations following the above definitions.

### Notation 1.

$$\tilde{J} ( t , k ) = ( {J}_{{c}_{1}} ( t , k ) , {J}_{{c}_{2}} ( t , k ) , ⋯ , {J}_{{c}_{N}} ( t , k ) ) ∈ {m d \times n}^{}$$

### Notation 2.

$$\tilde{H} = ( \begin{matrix}{H}_{1} & ⋯ & 0 \\ ⋮ & ⋱ & ⋮ \\ 0 & ⋯ & {H}_{N}\end{matrix} ) ∈ {n \times n}^{}$$

A notation vec(A) is used here to express the vectorization of a matrix A in column-first order. Then the gradient update rule can be expressed as:

$$v e c ( {W}_{c} ( t , k + 1 \} ) = vec ( {W}_{c} ( t , k ) ) - , {η}_{i} {J}_{c} ( t , k ) ( {y}_{c} ( t , k ) - {y}_{c} )$$

$$vec ( U ( t + 1 ) ) = v e c ( U ( t ) ) - \frac{{η}_{l} {η}_{g}}{N} {\sum }_{k} J ( t , k ) ( y ( t , k ) - y ) - ( 1 - λ ) \frac{{η}_{l} {η}_{g}}{N} {\sum }_{k} J ( t , k ) y ( t , k ) - y )$$

### C.2 Some Useful Results

A result from Huang et al. (2021) is cited here which will be used later.

Lemma 3. For J(t,k) as defined above, with probability at least 1−nexp(−mexp(−m(Rσ⁻¹+δ)/10)), it follows that:

$${‖ J ( t , k ) - J ( 0 , 0 ) ‖}_{F} \leq 2 n ( R {σ}^{- 1} + δ )$$

The following lemma give an approximation on the dynamics of the global model.

### Lemma 4. For

$$A ( λ ) = ( 1 - λ ) \frac{{η}_{l} {η}_{g} K}{N} {H}^{∞} + λ {η}_{l} K {\tilde{H}}_{c}^{∞} and β ( λ ) = ( 1 - λ ) \frac{{η}_{l} {η}_{g} K}{N} + λ {η}_{l} K ,$$

it follows that

$$y ( t ) - y = - {( I - A ( λ ) )}^{t} y + e ( t )$$

$$where$$

$${‖ e ( t ) ‖}_{2} \leq ( {( 1 - β ( λ ) {s}_{min} )}^{t} ( \sqrt{n} σ + \frac{t β ( λ ) {n}^{7 / 2}}{{s}_{min} σ \sqrt{m}} ) poly ( log ( m / δ ) )$$

Proof. Recall that from Appendix B, it follows that [y(t)−y]−[y(t−1)−y]=v₁+v₂+v₃, and that:

$${v}_{1 , {i}^{=}} - \frac{( 1 - λ ) {η}_{l} {η}_{g} K}{N} {\sum }_{j ∈ [ n ]} ( {y}_{j} ( t ) - {y}_{j} ) {H}_{i , j}^{∞} - \frac{( 1 - λ ) {η}_{l} {η}_{g}}{N} {\sum }_{j ∈ [ n ] , k} ( {y}_{j} ( t , k ) - {y}_{j} ( t ) {H}_{i , j}^{∞} - \frac{( 1 - λ ) {η}_{l} {η}_{g}}{N} {\sum }_{j ∈ [ n ] , k} ( {y}_{j} ( t ) - {y}_{j} ) ( {H ( t , k )}_{i , j} - {H}_{i , j}^{∞} ) - \frac{( 1 - λ ) {η}_{l} {η}_{g}}{N} {\sum }_{j ∈ [ n ] , k} ( {y}_{j} ( t , k ) - {y}_{j} ) ( {{H}^{⊥} ( t , k )}_{i , j} )$$

and similar for v_{2,i} except that i, j∈S_{c} for some client c.

### Let

$${ξ}_{i} ( t ) := {v}_{1 , i} ( t ) + {v}_{2 , i} ( t ) + {v}_{3 , i} ( t ) + \frac{( 1 - λ ) {η}_{l} {η}_{g} K}{N} {\sum }_{j ∈ [ n ]} ( {y}_{j} ( t ) - {y}_{j} ) {H}_{i , j}^{∞} + {λη}_{l} K {\sum }_{j ∈ {S}_{c}} ( {y}_{j} ( t ) - {y}_{j} ) {( {H}_{c}^{∞} )}_{i , j}$$

Note that by Appendix B,

$$‖ {v}_{3} ( t ) ‖ = \frac{16 {η}_{l} {\tilde{η}}_{g} K}{N} ( 1 + 2 {η}_{l} n K ) nR ‖ y - y ( t ) ‖ , ‖ {y}_{c} ( t ) - {y}_{c} ( t , k ) ‖ \leq 2 {η}_{l} nK ‖ {y}_{c} ( t ) - {y}_{c} ‖ , {‖ y - y ( t , k ) ‖}_{2} \leq 2 ( 1 + 2 {η}_{l} nK ) {‖ y - y ( t ) ‖}_{2} , {‖ H ( w , w ) - H ( {w}_{1} , {w}_{2} ) ‖}_{F} \leq 4 nR$$

$$and$$

$${‖ {H ( t , k )}^{⊥} ‖}_{F} \leq 4 nR$$

etc. By taking the maximum order among the terms, it follows that:

$${‖ ξ ( t ) ‖}_{2} \leq 𝒪 ( \frac{β ( λ ) {n}^{3} {s}_{max} \sqrt{log ( m δ ) {log}^{2} ( n / δ )}}{σ λ \sqrt{m}} {‖ y - y ( t ) ‖}_{2} )$$

$$where$$

$$β ( λ ) : = \frac{( 1 - λ ) {η}_{l} {η}_{g} K}{N} + λ {η}_{l} K$$

$$Then$$

$$\begin{matrix}y ( t ) - y = ( I - A ( λ ) ) ( y ( t - 1 ) - y ) + ξ ( t - 1 ) \\ = {( I - A ( λ ) )}^{t} ( y ( 0 ) - y ) + {\sum }_{τ ∈ [ t - 1 ]} {( I - A ( λ ) )}^{τ} ξ ( t - 1 - τ ) \\ = - {( I - A ( λ ) )}^{t} y + e ( t )\end{matrix}$$

$$where$$

$$e ( t ) = {( I - A ( λ ) )}^{t} y ( 0 ) + {\sum }_{τ ∈ [ t - 1 ]} {( I - A ( λ ) )}^{τ} ξ ( t - 1 - τ )$$

$$and since$$

$${‖ y ( 0 ) ‖}_{2}^{2} \leq n {σ}^{2} \cdot 2 log ( 2 mn / δ ) \cdot {log}^{2} ( 4 n / δ )$$

it follows that:

$$‖ e ( t ) ‖ \leq 𝒪 ( {( 1 − β ( λ ) {s}_{min} )}^{t} \leq ( \sqrt{n {σ}^{2}} \sqrt{2 log ( 2 mn / δ )} log ( 8 n / δ ) + t \frac{β ( λ ) {n}^{7 / 2} log ( m / δ ) {log}^{2} ( n / δ )}{{s}_{min} σ \sqrt{m}} ) ) \leq 𝒪 ( {( 1 − β ( λ ) {s}_{min} )}^{t} ( \sqrt{n} σ + \frac{t β ( λ ) {n}^{7 / 2}}{{s}_{min} σ \sqrt{m}} ) poly ( log ( m / δ ) )$$

### C.3 Average Generalization

When examining a new OOD sample, the average of all current parameters for prediction would be used. Therefore, the generalization performance of the average of all parameters is examined here:

$$W ( t ) : = \frac{1}{N} {\sum }_{c} {W}_{c} ( t )$$

By (7), it follows that:

$$v e c ( W ( t + 1 ) ) = v e c ( W ( t ) ) - \frac{λ {η}_{l}}{N} {\sum }_{k , c} {J}_{c} ( t , k ) ( {y}_{c} ( t , k ) - {y}_{c} ) - ( 1 - λ ) \frac{{η}_{l} {η}_{g}}{N} {\sum }_{k} J ( t , k ) ( y ( t , k ) - y )$$

### Lemma 5. For

$$A ( λ ) = ( 1 - λ ) \frac{{η}_{l} {η}_{g} K}{N} {H}^{∞} + λ {η}_{l} K {H}_{c}^{∞} and γ ( λ ) = ( 1 - λ ) \frac{{η}_{l} {η}_{g} K}{N} + λ \frac{{η}_{l} K}{N} ,$$

it follows that:

$${‖ W ( t ) − W ( 0 ) ‖}_{F} \leq {( {y}^{T} {A ( λ )}^{− T} {H}^{∞} {A ( λ )}^{− 1} y )}^{1 / 2} + ( \frac{n σ}{{s}_{min}} \cdot poly ( log ( m / δ ) ) + \frac{{n}^{4}}{{σ}^{1 / 2} {m}^{1 / 4}} \cdot poly ( log ( m / δ ) ) )$$

### Proof.

$$vec ( W ( T ) ) - vec ( W ( 0 ) ) = {\sum }_{t ∈ [ T - 1 ]} [ - ( 1 - λ ) \frac{{η}_{l} {η}_{g}}{N} {\sum }_{k} J ( t , k ) ( y ( t , k ) - y ) - \frac{{λη}_{l}}{N} {\sum }_{c} {\sum }_{k} {J}_{c} ( t , k ) ( {y}_{c} ( t , k ) - {y}_{c} ) ] = {\sum }_{t ∈ [ T - 1 ] , k} - \frac{γ ( λ )}{K} J ( t , k ) ( y ( t , k ) - y ) = {\sum }_{t ∈ [ T - 1 ] , k} \frac{γ ( λ )}{K} J ( t , k ) {( I - A ( λ ) )}^{t} y - {\sum }_{t ∈ [ T - 1 ] , k} \frac{γ ( λ )}{K} J ( t , k ) ( y ( t , k ) - y ( t ) + e ( k ) ) = {\sum }_{t ∈ [ T - 1 ]} γ ( λ ) J ( 0 , 0 ) {( I - A ( λ ) )}^{t} y + {\sum }_{t ∈ [ T - 1 ] , k} \frac{γ ( λ )}{K} ( J ( t , k ) - J ( 0 , 0 ) ) {( I - A ( λ ) )}^{t} y - {\sum }_{t , k} \frac{γ ( λ )}{K} ( J ( t , k ) ( y ( t , k ) - y ( t ) + e ( k ) ) = {B}_{1} + {B}_{2} + {B}_{3}$$

$$where$$

$${B}_{1} = {\sum }_{t ∈ [ T - 1 ]} γ ( λ ) J ( 0 , 0 ) {( I - A ( λ ) )}^{t} y$$

$${B}_{2} = {\sum }_{t ∈ [ T - 1 ] , k} \frac{γ ( λ )}{K} ( J ( t , k ) - J ( 0 , 0 ) ) {( I - A ( λ ) )}^{t} y$$

$${B}_{3} = {\sum }_{t , k} \frac{γ ( λ )}{K} J ( t , k ) ( y ( t , k ) - y ( t ) + e ( k ) )$$

Then by substituting in the following Statements, it follows that:

$${‖ W ( t ) − W ( 0 ) ‖}_{F} \leq {( {y}^{T} {A ( λ )}^{− T} {H}^{∞} {A ( λ )}^{− 1} y )}^{1 / 2} + 𝒪 ( \frac{n σ}{{s}_{min}} \cdot poly ( log ( m / δ ) ) + \frac{{n}^{4}}{{σ}^{1 / 2} {m}^{1 / 4}} \cdot poly ( log ( m / δ ) ) )$$

Statement 1. With probability at least 1−δ over random initialization, as t→∞, it follows that:

$${‖ {B}_{1} ‖}_{2}^{2} \leq {{y}^{T} ( {A ( λ )}^{- 1} )}^{T} {H}^{∞} {A ( λ )}^{- 1} y + 𝒪 ( \frac{{n}^{2} \sqrt{log ( n / δ )}}{{s}_{min}^{2} \sqrt{m}} )$$

Statement 2. With probability at least 1−δ over random initialization, it follows that:

$${‖ {B}_{2} ‖}_{2} \leq \frac{{n}^{3 / 2} poly ( log ( m / δ ) )}{{m}^{1 / 4} {σ}^{1 / 2} {s}_{min}^{3 / 2}}$$

### Statement 3.

$${‖ {B}_{3} ‖}_{2} \leq ( \frac{n σ}{{s}_{min}} + \frac{{n}^{4}}{{s}_{min}^{3} σ \sqrt{m}} ) \cdot poly ( log ( m / δ ) )$$

The above three Statements are the slightly modified version from Huang et al. (2021), So the proofs from there naturally extend to the proofs of these three statements.

Theorem 3. For T sufficiently large, σ=O(λpoly(log n, log(1/δ))/n)), m=Ω(σ⁻²(n¹⁶ poly (log n, log(1/δ),λ⁻¹))), the loss function 1 being 1-Lipschitz in its first argument, then with probability at least 1−δ over the random initialization, the population loss L_{D}(f) of the global model

$$W := \frac{1}{N} {\sum }_{c} {W}_{c}$$

is upper bounded by

$${L}_{𝒟} ( f ) \leq \sqrt{2 {y}^{T} {A ( λ )}^{- T} {H}^{∞} {A ( λ )}^{- 1} y / n} + 𝒪 ( \sqrt{log ( n / {s}_{min} δ ) / 2 n )} )$$

$$where A ( λ ) = ( 1 - λ ) \frac{{η}_{l} {η}_{g} K}{N} {H}^{∞} + λ {η}_{l} K {\tilde{H}}_{c}^{∞} .$$

Proof. This is an extension of the result in Huang et al. (2021), by substituting lemma 5 into the proof of Theorem C.11 in Huang et al. (2021).

### C.4 Client Level

For a further inspection of the algorithm, a client level generalization is now considered. That is, the generalization bound on a client's parameter W_{c} is considered. Note that:

$$vec ( {W}_{c} ( t + 1 ) ) = vec ( {W}_{c} ( t ) ) - λ {η}_{l} {\sum }_{k} {J}_{c} ( t , k ) ( {y}_{c} ( t , k ) - {y}_{c} ) - ( 1 - λ ) \frac{{η}_{l} {η}_{g}}{N} {\sum }_{k} J ( t , k ) ( y ( t , k ) - y )$$

A matrix defined here will be used later.

### Definition 6 (Cross Gram Matrix).

$${{H}_{c}^{\times } ( t , k )}_{i , j} = \frac{1}{m} {\sum }_{r} {x}_{i}^{T} {x}_{j} {{w}_{0 , r}^{T} {x}_{i} \geq 0 , {w}_{c , r}^{T} ( t , k ) {x}_{j} \geq 0}_{} ∈ {{n}_{c} \times n}^{}$$

where i∈S_{c} and j spans all clients.

This matrix describes the effect of the global update on the client's local model.

Theorem 4. For T sufficiently large, σ= [symbol] (λpoly(log n, log(1/δ))/n)), m=Ω(σ⁻²(n¹⁶ poly (log n, log(1/δ), λ⁻¹))), the loss function 1 being 1-Lipschitz in its first argument, then with probability at least 1−δ over the random initialization, the population loss L_{D}(f) of the client model We is upper bounded by

$${L}_{𝒟} ( f ) \leq \sqrt{2 {y}^{T} A {( λ )}^{- T} {G}_{c} ( λ ) A {( λ )}^{- 1} y / n} + 𝒪 ( \sqrt{log ( n / {s}_{min} δ ) / 2 n )} )$$

$$where {G}_{c} ( λ ) = {( 1 - λ )}^{2} \frac{{η}_{l}^{2} {η}_{g}^{2} {K}^{2}}{{N}^{2}} H + {λ}^{2} {η}_{l}^{2} {K}^{2} {H}_{c} + λ ( 1 - λ ) {η}_{l}^{2} {η}_{g} {K}^{2} {H}_{c}^{\times } .$$

This theorem is a natural extension of theorem 3, and the proof also naturally extends.

### APPENDIX D EXPERIMENTS

In this section, more experimental results and implementation details are disclosed. Sec. D.1 gives more details for implementation, including dataset details, model architectures, training, and testing details. Sec.D.2 shows more experiment results, including the performance regarding various batch sizes, and the complete evaluation metrics on the binary classification on the Camelyon 17 dataset.

### D.1 Experimental Details

The complete details of datasets, data splitting, and implementation details are now introduced.

Digits5. Digits-5 zhou2020learning,fedbn with digits images showing drastic differences in font style, color, and background. Each data source/style is taken as a client. A 6-layer convolutional neural network is trained for the digit classification, specifically, the model has 3 convolutional layers and 3 fully-connected layers, batch normalization layers are further added after the first five layers to fit the requirements of FedBN. The SGD optimizer is implemented with a learning rate of 0.01 and a batch size of 128. The loss function is the Cross Entropy loss. The total number of training rounds is 100 with a local update epoch of 1. All input images are resized to 28×28.

Office-Caltech10. Office-Caltech10 gong2012geodesic contains images acquired in different cameras or environments, with four different data sources in total. ResNet-18 is taken as the backbone and the SGD optimizer is implemented with a learning rate of 0.01 and batch size of 32. The loss function is the Cross Entropy loss. The total number of training rounds is 200 with a local update epoch of 1. The input images are normalized using the mean and std of Imagenet in PyTorch, which is specifically mean=[0.485, 0.456, 0.406] and std=[0.229, 0.224, 0.225]. All input images are resized to 256×256

DomainNet. DomainNet peng2019moment has images with different image styles (clipart, infograph, painting, quickdraw, real, and sketch). Following FedBN, the top-10 class is chosen based on data amount from DomainNet containing images over 345 categories for simplicity. The training settings are the same as the Office-Caltech10 dataset, and the training round is decreased from 200 to 100 since the model converges faster on the DomainNet dataset.

Camelyon17. Camelyon17 bandi2018detection shows histology images with different stains from 5 hospitals. All histopathology images are stained with the H.E. staining and show various appearances. The DenseNet121 is used as the backbone, SGD optimizer with a learning rate of 0.01, and batch size of 32. The model is trained for 40 rounds in total, and the local update epoch is 1. The image input size is 96×96. The loss function is the Cross Entropy loss. Note that this dataset is a very large dataset which contains over 450,000 histology images.

Retinal. Retinal fundus dataset contains retinal fundus images acquired from 6 different institutions (Fumero et al., 2011, Sivaswamy et al., 2015, Almazroa et al., 2018, Orlando et al., 2020). The U-Net for segmentation is used, the optimizer is Adam with a learning rate of 1e⁻³ and β=(0.9, 0.99). The model is trained for 100 communication rounds in total with a local update epoch of 1. The batch size is 8. The dice loss is used and both the Dice score and HD distance are reported. All images are resized to 256×256.

For all datasets, each data source is taken as one client and the data of each client is split into train, validation, and testing sets with a ratio of 0.6, 0.2, and 0.2. The best model is chosen based on the validation data and report the test performance accordingly.

### D.2 More Experiments

Here more experiment results are presented, which mainly include two parts. The first part is the study of the effects of batch size on our method's performance, and the second part is the complete evaluation results on the Camelyon 17 dataset.

Effects of batch sizes. As the implementation accumulates the feature matrix iteratively during local steps (Line 7 in the algorithm box), the batch size may slightly change the values of the feature matrix. In this case, the performance changes by using different batch sizes (4, 8, 16, 32, 64, 128) on the Digit5 dataset is further explored. The results are shown in Table 6. From the results it can be observed that changing batch size has very mild effects on the final performance, the overall accuracy changes are less than 1%. This further supports our implementation of iteratively accumulating the feature matrix during local SGD, which takes less computational cost than re-calculates all samples again after 1 local epoch.

TABLE 6
Performance using different batch sizes on the Digits dataset.

| Batchsize | MNIST | SVHN | USPS | Synth | MNISTM | Average |
|---|---|---|---|---|---|---|
| 8 | 99.40 | 93.53 | 98.92 | 99.70 | 97.19 | 97.75 |
| 16 | 99.49 | 93.85 | 98.87 | 99.68 | 97.41 | 97.86 |
| 32 | 99.40 | 93.37 | 99.03 | 99.62 | 96.86 | 97.66 |
| 64 | 99.37 | 92.87 | 98.87 | 99.50 | 96.14 | 97.35 |
| 128 | 99.25 | 92.17 | 98.71 | 99.42 | 95.71 | 97.05 |

Complete evaluation on Camelyon17. As the classification task on the Camelyon17 dataset is a binary classification, so the full evaluation metrics, including the Accuracy, AUC, sensitivity, specificity, and the F1-score are reported. From the Table. 7, it can be observed that our proposed method consistently outperforms all compared methods regarding all metrics.

TABLE 7
Complete evaluation metrics on the Camelyon17 dataset.

| | Accuracy | AUC | Sensitivity | Specificity | F1-score |
|---|---|---|---|---|---|
| FedAvg | 95.30 | 98.90 | 94.91 | 95.69 | 95.30 |
| APFL | 96.42 | 99.35 | 94.42 | 98.42 | 96.42 |
| L2SGD | 95.93 | 99.22 | 95.12 | 96.73 | 95.92 |
| FedAlt | 97.91 | 99.57 | 96.55 | 97.90 | 97.22 |
| PerFedAvg | 96.08 | 99.24 | 95.37 | 96.79 | 96.08 |
| FedBN | 95.77 | 99.15 | 95.02 | 96.53 | 95.77 |
| FedFOMO | 95.62 | 99.15 | 95.35 | 95.90 | 95.62 |
| FedRep | 96.78 | 99.39 | 96.78 | 96.79 | 96.78 |
| FedBABU | 95.77 | 99.15 | 95.03 | 96.52 | 95.77 |
| FedHKD | 95.89 | 98.43 | 93.89 | 94.67 | 94.28 |
| LG-Mix (Ours) | 98.75 | 99.89 | 98.63 | 98.87 | 98.75 |

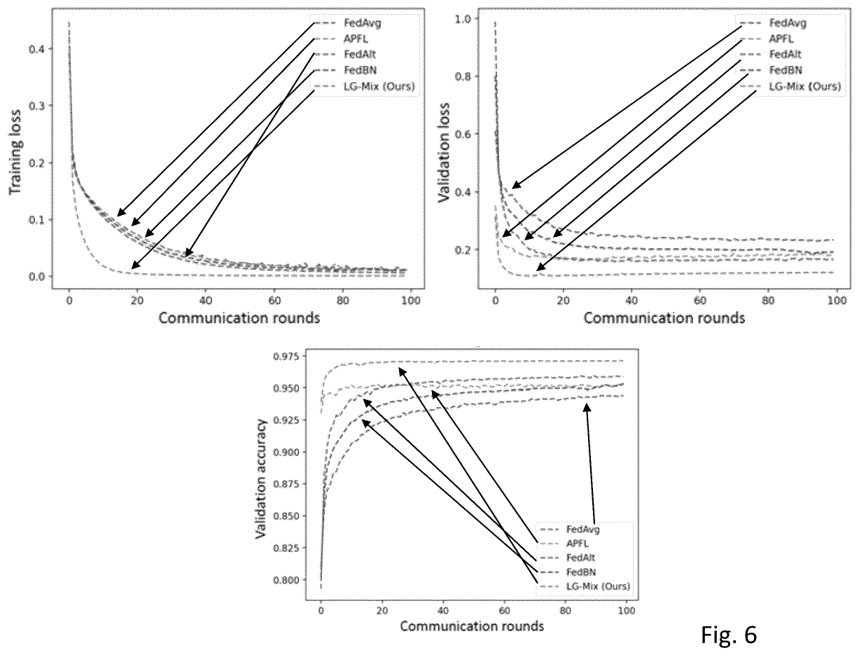

Loss and accuracy curves. The convergence speed of the method of the present invention is analyzed by comparing the training loss, validation loss and validation accuracy on the Digits5 dataset. The top 3 ranked methods on the Digits5 dataset are selected, and the results are shown in FIG. 6. From the figure, it can be observed that other methods show quicker convergence speed and higher validation performance than the baseline method FedAvg, and our method of the present invention further promotes the convergence speed, especially the training loss. These curves further demonstrate the efficacy of the convergence rate of our proposed method.

Training time costs. the training time costs are further investigated, and the wall-clock times are reported by comparing our method and others on all tasks. The GPU used for training is GeForce RTX 2080 Ti. The results are shown in Table 8. From the table, it can be observed that FedHKD takes a significant time cost than other methods, which is because it requires performing an extra validation process using different client models, in order to generate the hyper-knowledge. For method APFL, it needs to take an extra forward pass and also optimize the mixing ratio factor in their method by calculating the parameter differences. Please note that the time cost of FedRep, FedBABU, and FedHKD on the retinal dataset are not reported, because they are specifically designed for the classification task. Compared with all these methods, the method of the present invention shows a reasonable computational time cost. The cost is slightly higher than some baseline methods, but it is a trade-off between the computational cost and performance.

TABLE 8
Wall-clock time (hours) for different methods on different tasks.

| Method | Digits5 | OfficeCaltech10 | DomainNet | Camelyon17 | Retinal |
|---|---|---|---|---|---|
| FedAvg | 3.70 | 1.28 | 17.37 | 55.01 | 25.95 |
| APFL | 4.38 | 1.70 | 19.59 | 79.12 | 26.36 |
| L2SGD | 3.83 | 1.40 | 18.42 | 57.17 | 26.79 |
| FedAlt | 4.09 | 1.47 | 28.77 | 76.80 | 34.16 |
| PerFedAvg | 3.79 | 1.45 | 18.66 | 56.97 | 26.44 |
| FedBN | 3.73 | 1.26 | 17.43 | 55.03 | 26.56 |
| FedFOMO | 6.02 | 2.80 | 19.04 | 76.80 | 36.90 |
| FedRep | 4.32 | 1.41 | 19.18 | 55.77 | — |
| FedBABU | 3.96 | 1.31 | 15.92 | 62.12 | — |
| FedHKD | 22.43 | 2.64 | 37.33 | 68.71 | — |
| LG-Mix (Ours) | 5.86 | 1.32 | 18.92 | 57.98 | 26.55 |

TABLE 9
GPU memory cost (MB) comparison on different tasks.

| Method | Digits5 | OfficeCaltech10 | DomainNet | Camelyon17 | Retinal |
|---|---|---|---|---|---|
| FedAvg | 270.24 | 1042.32 | 1042.32 | 1096.89 | 1814.29 |
| APFL | 600.77 | 2993.48 | 2993.48 | 2955.24 | 4504.02 |
| L2SGD | 456.18 | 2057.62 | 1157.62 | 2072.09 | 2329.91 |
| FedAlt | 458.27 | 1042.33 | 1042.33 | 1096.89 | 2297.57 |
| PerFedAvg | 270.24 | 1042.32 | 1042.32 | 1096.89 | 1814.29 |
| FedBN | 458.27 | 1042.32 | 1042.32 | 1097.99 | 2295.21 |
| FedFOMO | 458.28 | 1948.98 | 1948.98 | 1985.06 | 2837.97 |
| FedRep | 458.27 | 1042.30 | 1042.30 | 1096.89 | — |
| FedBABU | 458.27 | 1042.30 | 1042.30 | 1096.89 | — |
| FedHKD | 864.28 | 3589.56 | 3589.56 | 3021.02 | — |
| LG-Mix (Ours) | 472.37 | 2101.01 | 2101.01 | 1905.38 | 3730.69 |

GPU memory cost. the GPU memory cost have been investigated by comparing the method of the present invention and others. Compared with FedAvg, our method of the present invention additionally stores a copy of the global model during local training, and it calculates the trace of latent feature matrices. the peak GPU memory cost of each method is tracked and the costs on different tasks are listed in Table 9. It can be observed that APFL and FedHKD show significantly higher GPU memory costs than others, which is because they require more memory to store the local copy of the global model. Specifically, APFL stores the local model, the local copy of the global model, and a local personalized model. FedHKD requires storing local models from other clients to generate the hyper knowledge for distillation. The method of the present invention lies in a reasonable range of GPU memory cost while presenting higher performance. Please note that FedRep, FedBABU, and FedHKD on the retinal dataset are not reported because they are specifically designed for the classification task.

Extended experiments on the BCI dataset. The evaluation from the image domain is extended to the Brain-Computer Interface (BCI) data, which consists of classifying the mental imagery EEG datasets. Specifically, four datasets from the MOABB benchmark are used (Jayaram & Barachant. 2018). These four datasets (AlexMI, BNCI2014_001, BNCI2015_004, Zhou2016) contain common classes of right hand and feet. The covariance matrix representations of each EEG signal as a feature are estimated and the tangent space projection for the matrices is performed. The final input of each dataset is a 1-d vector, and zero-paddings are added to have the same input dimension. The method of the present invention is compared with others and reported the performance under five metrics is reported in Table 10. From the table, it can be observed that PFL methods show better performance than the FedAvg on such heterogeneous features, while the method of the present invention outperforms all compared methods on five metrics. This further validates the efficacy of the method of the present invention on 1-d signal data.

TABLE 10
Comparison of the BCI dataset.

| Method | Accuracy | AUC | Sensitivity | Specificity | F1-score |
|---|---|---|---|---|---|
| FedAvg | 67.38 | 69.71 | 68.14 | 66.77 | 67.29 |
| APFL | 71.01 | 75.48 | 71.21 | 71.08 | 70.97 |
| L2SGD | 67.39 | 69.96 | 69.11 | 65.88 | 67.31 |
| FedAlt | 68.46 | 72.74 | 69.72 | 67.52 | 68.45 |
| PerFedAvg | 67.47 | 71.25 | 64.22 | 70.56 | 67.35 |
| FedBN | 68.06 | 70.62 | 68.28 | 68.03 | 68.03 |
| FedFOMO | 64.69 | 68.56 | 65.36 | 64.18 | 64.53 |
| FedRep | 68.10 | 69.82 | 69.75 | 66.68 | 68.01 |
| FedBABU | 68.03 | 70.45 | 69.99 | 66.25 | 67.95 |
| FedHKD | 68.69 | 70.34 | 64.99 | 72.32 | 68.44 |
| LG-Mix (Ours) | 73.74 | 78.11 | 75.19 | 72.58 | 73.72 |

### Appendix E Discussions

In this specification, a novel PFL system and method is disclosed which aims at addressing the challenges posed by heterogeneous features during the training process. The method of the present incorporates considerations of the convergence rate of both local and global models. To achieve the model personalization, the trace of the Gram matrix using local/global updates for gradient descent is taken as an approximation of the convergence rate. By employing the ratio of the trace, a linear combination of local and global updates is performed. Additionally, due to the substantial increase in computational costs associated with the Gram matrix as the number of samples grows, one embodiment of the present invention further approximates the calculation by calculating the trace of a latent feature matrix. The latent feature is extracted from the last hidden layer. The method of the present invention considers the feature matrix to mix local and global updates. While this approximation is reasonable and reflects the convergence rate in principle, the estimation when using large foundation models as the model backbone may not be very accurate in some situations. When using large foundation models, such as pre-trained deep neural networks, the convergence behavior may differ due to the model's architecture and complexity. In such cases, relying solely on the last-layer latent feature for trace approximation might capture part of the true convergence rate accurately. There is a risk factor of obtaining less precise estimations in these scenarios. To address this limitation and obtain more comprehensive measurements for combining local and global updates, one approach is to consider the prediction errors of local and global models. By incorporating the model errors into the mixing process, it is possible to gain insights into the convergence behavior of the models. This further method would provide a more holistic perspective on the convergence rate and guide the combination of local and global updates more effectively.

The method of the present invention aims to improve the personalization of client models for heterogeneous features. This can have industrial applications in various fields, such as healthcare, where medical images collected from different hospitals are heterogeneous. By improving the model personalization, our method can potentially improve the accuracy and effectiveness for better healthcare outcomes. The method of the present invention also has several potential implications for future applications. First, the method of the present invention provides a new perspective on addressing heterogeneous features in PFL, and can be extended to segmentation asks, whereas many existing PFL methods are only validated on classification tasks. Second, the method of the present invention uses an NTK viewpoint for analyzing the PFL method by combining local and global updates, it can extend to the NTK framework for analyzing the general PFL frameworks.

One of the prior art systems proposed to mix the local and global models and select the ratio based on the differences observed between the mixed model and the global model. However, considering that the local/global update strongly correlates with the input data, attention in this prior art fails to give attention to the data aspect in the context of feature heterogeneous PFL. To answer this question, one embodiment of the present invention provides a Neural Tangent Kernel (NTK), which leverages the dot product of input data for measuring the convergence of neural network training. By calculating the NTK matrix when employing local and global updates, that embodiment of the present invention can take the NTK-based convergence rate as a guiding factor to adaptively adjust the mixing ratio.

The invention claimed is:

1. A computing system comprising:
a local processing unit having a local artificial intelligence (AI) engine for training a first set of input data to generate a local update, and
a remote server having a global AI engine for aggregating one or more client AI engines for training a second set of input data to generate a global update;
wherein the first set of input data has an identical sample space to that of the second set of input data, and the first set of input data has a different feature space from the second set of input data;
wherein the local AI engine is adapted to generate a local model based on a combination of the local update and the global update received from the remote server by the local processing unit in accordance with a ratio calculated by a convergence function.

2. A computing system of claim 1, wherein the convergence function depends on a Gram matrix H(t).

3. A computing system of claim 2, wherein the Gram matrix H(t) is generated by a function of parameter w and input x of an AI engine.

4. A computing system of claim 3, wherein the ratio between the local update and global update are λ_{c}, and 1−_{c} respectively.

5. A computing system of claim 4, wherein λ_{c}(t)=tr(H_{c}(t))/(tr(H_{c}(t))+tr(H(t))) and tr(H) is a trace of a matrix H.

6. A computing system of claim 4, wherein λ_{c}(t)=tr(Σ_{c}(t))/(tr(Σ_{c}(t))+tr(Σ(t))), wherein h denotes the parameters up to the penultimate layer of an AI engine,
$$\sum ( t ) = {\sum }_{i = 1}^{n} h ( {x}_{i} ) {h ( {x}_{i} )}^{T}$$
is a feature matrix in [symbol] ^{m×m} considering features among all samples.

7. A computing system of claim 6, wherein
$${λ}_{c} ( t ) = \frac{1}{t - 1} {\sum }_{i = 1}^{t - 1} {λ}_{c} ( i ) .$$

8. A computing system of claim 1, wherein the AI engine comprises any one of an artificial neural network, a convolution neural network, or a U-Net.

9. A computing system of claim 1, wherein the global AI engine is adapted to generated a global update by aggregating one or more remote client updates received from one or more remote client AI engine, such that the global updates Δu(t)=Σ_{c}p_{c}Δw_{c}(t), wherein p_{c} denotes the client importance.

10. A computing system of claim 1, further comprises a method of generating a outside personalisation model, wherein the method of generating a outside personalisation model comprising the steps of:
initialising R(n,l)=1/(N+1) for all n=[N+1], l=[L] for building a build routing
space \tilde{W}=R·[w₁, . . . , W_{N}, u]^{T} with the steps of:
for samples i=1, . . . , no do
$${\overline{y}}_{i}^{o} = {f}_{{w}_{o}} ( {x}_{i}^{o} )$$
model inference,
R=_{R} [symbol] ₜ test-time update, where
$${ℒ}_{t} = {ℒ}_{cons} ( {x}_{i}^{o} , {x}_{i}^{o} + ϵ ; R ) + β ( {ℒ}_{s} ( {x}_{i}^{o} ; R ) + {ℒ}_{e} ( {x}_{i}^{o} ; R ) ) ,$$
$${w}_{o} = R \cdot {[ {w}_{1} , ... , {W}_{N} , u ]}^{⊤} .$$

11. A computer-implemented method comprising:
processing a first set of input data with a local AI engine, wherein the AI engine has an input layer, a hidden layer, an output layer, and a loss function model, to obtain a local update;
receiving a global update from a remote server, wherein the remote server has a global AI engine for aggregating one or more client AI engines for training a second set of input data; and wherein the first set of sample data has an identical sample space to that of the second set of input data, and the first set of sample data has a different feature space from the second set of input data;
generating a local model based on a combination of the local update and the global update received from the remote server by the local processing unit in accordance with a ratio calculated by a convergence function.

12. A computer-implemented method of claim 11, wherein the convergence function depends on a Gram matrix H(t).

13. A computer-implemented method of claim 12, wherein the Gram matrix H(t) is generated by a function of parameter w and input x of an AI engine.

14. A computer-implemented method of claim 13, wherein the ratio between the local update and global update are λ_{c}, and 1−λ_{c} respectively.

15. A computer-implemented method of claim 14, wherein λ_{c}(t)=tr(H_{c}(t))/(tr(H_{c}(t))+tr(H(t))) and tr(H) is a trace of a matrix H.

16. A computer-implemented method of claim 14, wherein λ_{c}(t)=tr(Σ_{c}(t))/(tr(Σ_{c}(t))+tr(Σ_{c}(t))), wherein h denotes the parameters up to the penultimate layer of an AI engine,
$$\sum ( t ) = {\sum }_{i = 1}^{n} h ( {x}_{i} ) {h ( {x}_{i} )}^{T}$$
is a feature matrix in [symbol] ^{m×m} considering features among all samples.

17. A computer-implemented method of claim 16, wherein
$${λ}_{c} ( t ) = \frac{1}{t - 1} {\sum }_{i = 1}^{t - 1} {λ}_{c} ( i ) .$$

18. A computer-implemented method of claim 11, wherein the AI engine comprises any one of an artificial neural network, a convolution neural network, or a U-Net.

19. A computer-implemented method of claim 11, wherein the global AI engine is adapted to generated a global update by aggregating one or more remote client updates received from one or more remote client AI engine, such that the global updates Δu(t)=Σ_{c}p_{c}Δw_{c}(t), wherein p_{c} denotes the client importance.

20. A computing system for processing medical images comprising:
a local processing unit having a local U-Net artificial intelligence (AI) engine for training a first set of input data to generate a local update, and
a remote server having a global AI engine for aggregating one or more client U-Net AI engines for training a second set of input data to generate a global update;
wherein the first set of input data comprises medical images collected from one medical imaging device, and the second set of input data comprises medical images collected from one or more different medical image devices, such that the first set of input data exhibits appearance misalignment from the second set of input data;
wherein the local AI engine is adapted to generate a local model based on a combination of the local update and the global update received from the remote server by the local processing unit in accordance with a ratio λ_{c}, to 1−λ_{c} calculated by a convergence function that depends on a Gram matrix H(t) generated by a function of parameter w and input x of an AI engine;
and λ_{c}(t)=tr(Σ_{c}(t))/(tr(Σ(t))+tr(Σ(t))), wherein h denotes the parameters up to the penultimate layer of an AI engine,
$$\sum ( t ) = {\sum }_{i = 1}^{n} h ( {x}_{i} ) {h ( {x}_{i} )}^{T}$$
is a feature matrix in [symbol] ^{m×m} considering features among all samples.
